(19) United States
(12) Patent Application Publication
(10) Pub. No.: US 2025/0326946 A1
(43) Pub. Date: Oct. 23, 2025

(54) COATING AGENT AND MULTILAYER STRUCTURE USING SAME

(71) Applicant: Kuraray Co., Ltd., Okayama (JP)

(72) Inventors: Takeshi SAKANO, Hiroshima (JP); Yasuhiro NONAKA, Mumbai (IN)

(73) Assignee: Kuraray Co., Ltd., Okayama (JP)

(21) Appl. No.: 18/868,546

(22) PCT Filed: May 23, 2023
(86) PCT No.: PCT/JP2023/019219

§ 371 Date: Nov. 22, 2024

(30) Foreign Application Priority Data
May 23, 2022 (JP) 2022-083834
May 23, 2022 (JP) 2022-083835

(51) Int. Cl. C09D 123/08; B32B 7/12; B32B 27/10; B32B 27/32; C08K 3/36; C09D 7/20; C09D 7/40; C09D 7/61; D21H 19/20

(52) U.S. Cl. CPC C09D 123/0861; B32B 7/12; B32B 27/10; B32B 27/32; C08K 3/36; C09D 7/20; C09D 7/61; C09D 7/68; C09D 7/69; D21H 19/20; B32B 2255/12; B32B 2255/26; B32B 2255/28; B32B 2307/31; B32B 2307/7244; B32B 2307/7376; B32B 2439/70

(57) ABSTRACT

The present disclosure provides a coating agent containing a modified ethylene-vinyl alcohol copolymer.

### TECHNICAL FIELD

The present invention relates to a coating agent comprising a modified ethylene-vinyl alcohol copolymer, and a multilayer structure therewith.

### BACKGROUND ART

Ethylene-vinyl alcohol copolymers (hereinafter, occasionally abbreviated as EVOH(s)) are excellent in gas barrier properties, oil resistance, and solvent resistance, and are preferably used for packaging materials in various fields of packaging, films, sheets, containers, and so on. EVOHs are often used as a layer of a multilayer structure, and in this case, forming an EVOH coating film by coating with an EVOH solution is also a common practice. Under the recent social trend toward the circular economy, excessive packaging to provide packaging materials with functions more than necessary is avoided. From the viewpoint of imparting minimum required functions to packaging materials, a precise thickness control technique for EVOH layers has been demanded. On the other hand, recycling of packaging materials to reuse them as packaging materials also contributes to the circular economy, for example, each EVOH does not have adverse influence on the recyclability of polyolefin resin even if a small amount of the EVOH is mixed therein, but comes to cause deteriorated recyclability as the proportion of the EVOH in a packaging material increases. Accordingly, an EVOH that develops high gas barrier properties even in a small amount has been demanded.

Water-containing alcohol is commonly used as a solvent for EVOH solutions (Patent Literature 1). EVOH solutions for coating are typically needed to be stored at normal temperature for a long period of time, and the storage temperature often varies between day and night. However, conventional EVOH solutions are poor in storage stability particularly at low temperature and tend to gel, thus requiring storage at a high temperature of 50° C. or more or redissolution by heating before application. If an EVOH in a solution whitens because of aggregation or the like during storage, thickness unevenness is caused in an EVOH coating film given by application. The thickness unevenness of an EVOH coating film leads to deterioration in gas barrier properties required for packaging materials, and hence needs to be managed with an application thickness more than necessary. In addition, after coating with an EVOH solution, a phenomenon such as whitening and fogging occurs in the coating film for some drying conditions, and hence strict condition management that allows the phenomenon to be prevented is required.

Examinations have been previously made to solve the problems, and it has been reported that a water-containing alcohol solution of an EVOH modified with vinylpyrrolidone is excellent in storage stability (Patent Literature 2). In addition, it has been reported that a water-containing alcohol solution of an EVOH containing boric acid and a water-containing alcohol solution of an EVOH containing an ether group are also excellent in storage stability (Patent Literatures 3, 4).

Imparting gas barrier properties to paper packages is important for preventing the oxidation degradation of contents. Laminating gas barrier layers including a first layer containing an ethylene-modified polyvinyl alcohol resin and an inorganic laminar compound and a second layer consisting of an ethylene-modified polyvinyl alcohol on a paper sheet has been proposed for that purpose (Patent Literature 5). To extend the expiration dates of contents, sterilization techniques are also used in combination. A retortable paper cup has been proposed as a paper barrier packaging material that is applied to retort sterilization techniques (Patent Literature 6).

### CITATION LIST

### Patent Literature

Patent Literature 1: JP 47-48489 A
Patent Literature 2: JP 63-139954 A
Patent Literature 3: JP 2-47144 A
Patent Literature 4: JP 2004-161854 A
Patent Literature 5: JP 2009-184138 A
Patent Literature 6: JP 2014-5031 A

### SUMMARY OF INVENTION

### Technical Problem

While the storage stability in solution is improved by employing any of the methods disclosed in aforementioned Patent Literatures 2 to 4, however, the effect is not necessarily enough. Accordingly, an EVOH solution much excellent in storage stability and a coating agent containing it have been desired. It has also been desired to achieve both such storage stability and gas barrier properties in an EVOH coating film to be formed after application.

It has been found that the laminate containing an ethylene-modified polyvinyl alcohol resin as disclosed in Patent Literature 5 is excellent in gas barrier properties, but may undergo generation of cracks in a package having a sharply angled flexural part to deteriorate the storability of contents, thus leaving room for improvement.

The present invention has been made in view of the problems, and an object of the present invention is to provide a coating agent that shows good storage stability in solution and gives a coating film having good appearance and gas barrier properties after application. Another object of the present invention is to provide a multilayer structure with such a coating agent. Still another object of the present invention is to provide a multilayer structure that has good gas barrier properties in spite of using a paper substrate and is capable of maintaining the good gas barrier properties after bending.

### Solution to Problem

The present inventors have diligently examined to find that enhanced storage stability in solution can be achieved by using a coating agent containing a specific modified ethylene-vinyl alcohol copolymer, and a coating film having good appearance and gas barrier properties is given by applying the coating agent, and further examinations based on the finding has led to the present invention.

The problems can be solved by providing a coating agent comprising a modified ethylene-vinyl alcohol copolymer (A), wherein the modified ethylene-vinyl alcohol copolymer (A) contains structural units (Ia), (Ib), and (Ic) represented by formulas shown below, the content ratios (mol %) of the structural units (Ia), (Ib), and (Ic), a, b, and c, satisfy expressions (1) to (3) shown below, the modified ethylene-vinyl alcohol copolymer (A) has a degree of saponification (DS), as expressed by expression (4) shown below, of 90 mol % or more:

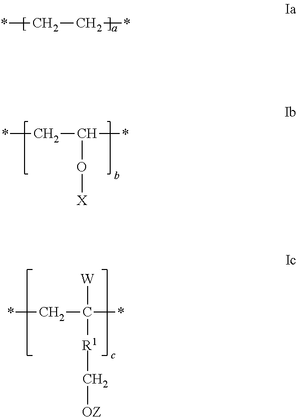

$$21 \leq a \leq 55 \qquad ( 1 )$$

$$0.1 \leq c \leq 10 \qquad ( 2 )$$

$$[ 100 - ( a + c ) ] \times 0.9 \leq b \leq [ 100 - ( a + c ) ] \qquad ( 3 )$$

$$D S = [ ( total number of moles of hydrogen atoms among X , Y , and Z groups ) / ( total number of moles of X , Y , and Z groups ) ] \times 100 \qquad ( 4 )$$

wherein each of a, b, and c is the content ratio (mol %) of the corresponding structural unit to 100 mol % of the total of all the structural units; W represents a methyl group or a group represented by R²—OY; X, Y, and Z each independently represent a hydrogen atom, a formyl group, or an alkanoyl group having 2 to 10 carbon atoms; R¹ represents a single bond, an alkylene group having 1 to 9 carbon atoms, or an alkyleneoxy group having 1 to 9 carbon atoms, wherein each of the alkylene group and the alkyleneoxy group optionally contains a hydroxy group, an alkoxy group, or a halogen atom; R² represents an alkylene group having 1 to 9 carbon atoms or an alkyleneoxy group having 1 to 9 carbon atoms, wherein each of the alkylene group and the alkyleneoxy group optionally contains a hydroxy group, an alkoxy group, or a halogen atom; and * indicates a bonding site.

In this case, it is preferable that, in the structural unit (Ic), W be a group represented by R²—OY, R¹ be a single bond, R² be a methylene group, and Y and Z be each a hydrogen atom. It is also preferable that the modified ethylene-vinyl alcohol copolymer (A) have a degree of saponification (DS) of 99 mol % or more. It is also preferable that the coating agent have a content of the modified ethylene-vinyl alcohol copolymer (A) of 1 to 50% by weight.

It is also preferable that the coating agent comprise an ethylene-vinyl alcohol copolymer (B) other than the modified ethylene-vinyl alcohol copolymer (A), and the ethylene-vinyl alcohol copolymer (B) have an ethylene content of 21 to 55 mol %. It is also preferable that the coating agent have a total content of the modified ethylene-vinyl alcohol copolymer (A) and the ethylene-vinyl alcohol copolymer (B) of 1 to 50% by weight. It is preferable that the coating agent comprise 10 to 10,000 ppm of inorganic microparticles having an average particle size of 0.1 to 10 μm. It is also preferable that the inorganic microparticles be made of amorphous silica.

It is preferable that the coating agent contain a solvent, and the solvent be a mixed solvent of an alcohol and water. In this case, it is more preferable that the difference (T₀-T₇) between the light transmittance of the coating agent at a wavelength of 800 nm for an optical path length of 1 cm after storage at 20° C. for 7 days, T₇ (%), and the light transmittance of the coating agent at a wavelength of 800 nm for an optical path length of 1 cm before storage, T₀ (%), be 20% or less. It is more preferable that the change rate of the solution viscosity of the coating agent after storage thereof at 20° C. for 1 week be 50% or less to the solution viscosity of the coating agent before the storage.

A multilayer structure formed by applying the coating agent onto a substrate is a preferred embodiment of the present invention.

A multilayer structure comprising a layer formed by applying the coating agent and a paper layer is also a preferred embodiment of the present invention. In this case, it is more preferable that the paper layer have a basis weight of 15 to 800 g/m². It is also more preferable that the modified ethylene-vinyl alcohol copolymer (A) contain an alkali metal ion, and have an alkali metal ion content of 2.5 to 22 μmol/g. It is also more preferable that the multilayer structure have an oxygen transmission rate of 20 cc/(m²·day·atm) or less as measured under conditions of 20° C. and 65% RH in accordance with JIS-K7126-2 (2006) Part 2 (Equal-pressure method). It is also more preferable that the multilayer structure have a heat-seal strength of 300 gf/15 mm or more as measured at a width of 15 mm in accordance with JIS Z 0238.

It is also more preferable that the multilayer structure further comprise an intermediate layer and a sealant layer. It is even more preferable that the intermediate layer contain a thermosetting resin or a thermoplastic resin (f). It is also even more preferable that the sealant layer contain a thermoplastic resin (g). It is particularly preferable that the thermoplastic resin (f) and the thermoplastic resin (g) each contain at least one selected from the group consisting of polyethylene, polypropylene, modified polyethylene, and modified polypropylene.

It is also more preferable that the weight of the paper layer, M1, and the total weight of the other layer(s), M2, satisfy the following expression (5):

$$1 \leq M 1 / M 2 \leq 300. \qquad ( 5 )$$

A package comprising the multilayer structure with one or more bent parts is a preferred embodiment of the multilayer structure. In this case, it is more preferable that a content to be contained in the package is a food, and the food has a water activity of 0.10 to 0.94.

### Advantageous Effects of Invention

The present invention provides a coating agent that is excellent in storage stability in solution and further gives a coating film having good appearance and gas barrier properties after application. A multilayer structure formed by applying such a coating agent onto a substrate has good appearance and gas barrier properties. A multilayer structure comprising a layer formed by applying such a coating agent and a paper layer has good gas barrier properties in spite of using a paper substrate (paper layer) and maintains the good gas barrier properties even after bending.

### BRIEF DESCRIPTION OF DRAWING

FIG. 1 is a diagram illustrating an example of a vertical filling-and-sealing bag including the multilayer structure of the present invention.

### DESCRIPTION OF EMBODIMENTS

Hereinafter, embodiments of the present invention (hereinafter, occasionally referred to as “the present embodiment”) will be each described on the basis of an example. However, the embodiments shown below are examples for embodying the technical ideas of the present invention, and the present invention is not limited to the description shown below. Although preferred modes of each embodiment are herein shown, a combination of two or more of the individual preferred embodiments is also a preferred mode. If several numerical ranges are given to a matter shown with a numerical range, a lower limit value and an upper limit value can be selected from them and combined as a preferred mode. Herein, the statement of a numerical range “XX to YY” means “XX or more and YY or less”.

### [Modified Ethylene-Vinyl Alcohol Copolymer (A)]

The modified ethylene-vinyl alcohol copolymer (A) used in the coating agent of the present invention contains structural units (Ia), (Ib), and (Ic) represented by formulas shown below. Hereinafter, the modified ethylene-vinyl alcohol copolymer (A) is occasionally abbreviated as the modified EVOH (A).

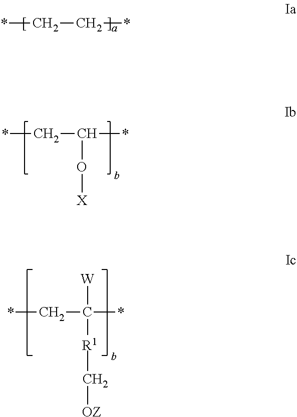

In the formulas, each of a, b, and c is the content ratio (mol %) of the corresponding monomer unit to 100 mol % of the total of all the monomer units, W represents a methyl group or a group represented by R²—OY, X, Y, and Z each independently represent a hydrogen atom, a formyl group, or an alkanoyl group having 2 to 10 carbon atoms, and R¹ represents a single bond, an alkylene group having 1 to 9 carbon atoms, or an alkyleneoxy group having 1 to 9 carbon atoms. Each of the alkylene group and the alkyleneoxy group optionally contains a hydroxy group, an alkoxy group, or a halogen atom. R² represents an alkylene group having 1 to 9 carbon atoms or an alkyleneoxy group having 1 to 9 carbon atoms, wherein each of the alkylene group and the alkyleneoxy group optionally contains a hydroxy group, an alkoxy group, or a halogen atom. * indicates a bonding site.

In the present invention, the modified EVOH (A) contains structural units (Ia), (Ib), and (Ic) represented by the above formulas, and the content ratios (mol %) of the structural units (Ia), (Ib), and (Ic), a, b, and c, satisfy the following expressions (1) to (3):

$$21 \leq a \leq 55 \qquad ( 1 )$$

$$0.1 \leq c \leq 10 \qquad ( 2 )$$

$$[ 100 - ( a + c ) ] \times 0.9 \leq b \leq [ 100 - ( a + c ) ] . \qquad ( 3 )$$

In the present invention, the modified EVOH (A) has a degree of saponification (DS), as expressed by the following expression (4), of 90 mol % or more:

$$D S = [ ( total number of moles of hydrogen atoms among X , Y , and Z groups ) / ( total number of moles of X , Y , and Z groups ) ] \times 100. \qquad ( 4 )$$

The modified EVOH (A) used in the present invention has units each having a quaternary carbon in the main chain in addition to ethylene units and vinyl alcohol units. The quaternary carbon in the main chain has an effect of inhibiting crystallization through steric hindrance, and functions to increase solution stability. In addition, the modified EVOH (A) has a primary hydroxy group, and hence develops high gas barrier properties due to strong hydrogen bonding force. Accordingly, use of the coating agent comprising the modified EVOH (A) results in high solution stability, and in enhanced gas barrier properties in a coating film to be formed after application.

In the structural unit (Ic), R¹ represents a single bond, an alkylene group having 1 to 9 carbon atoms, or an alkyleneoxy group having 1 to 9 carbon atoms, wherein the alkylene group and the alkyleneoxy group each optionally contains a hydroxy group, an alkoxy group, or a halogen atom. It is preferable that R¹ be a single bond. The number of carbon atoms of the alkylene group is preferably 5 or less, more preferably 3 or less, and even more preferably 2 or less. The number of carbon atoms of the alkyleneoxy group is preferably 5 or less, more preferably 3 or less, and even more preferably 2 or less.

In the structural unit (Ic), W represents a methyl group or a group represented by R²—OY, and Y and Z each independently represent a hydrogen atom, a formyl group, or an alkanoyl group having 2 to 10 carbon atoms. For further enhancement of stability in solution and gas barrier properties, it is preferable that W be a methyl group or a group represented by R²—OH (i.e., Y is a hydrogen atom), and it is more preferable that W be a group represented by R²—OH (i.e., Y is a hydrogen atom) and Z be a hydrogen atom. R² in the group represented by R²—OH is preferably an alkylene group, more preferably an ethylene group or a methylene group, and even more preferably a methylene group.

In the structural unit (Ic), R² represents an alkylene group having 1 to 9 carbon atoms or an alkyleneoxy group having 1 to 9 carbon atoms, wherein the alkylene group and the alkyleneoxy group each optionally contain a hydroxy group, an alkoxy group, or a halogen atom. It is preferable that R² be the alkylene group. The number of carbon atoms of the alkylene group is preferably 5 or less, more preferably 3 or less, and even more preferably 2 or less. The number of carbon atoms of the alkyleneoxy group is preferably 5 or less, more preferably 3 or less, and even more preferably 2 or less. In the structural unit (Ic), it is preferable that W be a group represented by R²—OY, R¹ be a single bond, R² be a methylene group, and Y and Z be each a hydrogen atom.

If X, Y, or Z in the structural units (Ib) and (Ic) is a hydrogen atom, then the modified EVOH (A) has a hydroxy group; if X, Y, or Z is a formyl group or an alkanoyl group, then the modified EVOH (A) has an ester group. The alkanoyl group is preferably an alkanoyl group having 2 to 5 carbon atoms, more preferably an acetyl group, a propanoyl group, or a butanoyl group, and even more preferably an acetyl group. Each set of X groups, Y groups, and Z groups is preferably hydrogen atoms or a mixture including a hydrogen atom.

Examples of the structural unit (Ic) include structural units (IIc) and (IIIc) represented by formulas shown below, and the structural unit (IIc) is especially preferable.

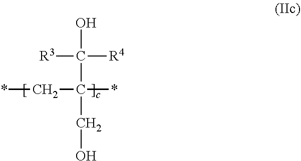

In the structural unit (IIc). R³ and R⁴ each independently represent a hydrogen atom or an alkyl group having 1 to 8 carbon atoms, wherein the alkyl group optionally contains a hydroxy group, an alkoxy group, or a halogen atom.

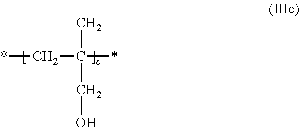

In the present invention, it is preferable for enhanced gas barrier properties that R³ and R⁴ in the structural unit (IIc) be each a hydrogen atom.

In the modified EVOH (A), a indicates the content ratio (mol %) of (Ia) to all the monomer units, and the content ratio of (Ia), a, is 21 to 55 mol % (expression (1)). If the content ratio a is less than 21 mol %, lowered thermal stability is caused, and gels and hard spots are frequently generated in melt-kneading for recycling. The content ratio a is preferably 26 mol % or more, and more preferably 30 mol % or more. If the content ratio a is more than 55 mol %, on the other hand, the gas barrier properties of the modified EVOH (A) under low humidity (e.g., a humidity of 65%) are insufficient. The content ratio a is preferably 52 mol % or less, and more preferably 46 mol % or less.

In the modified EVOH (A), c indicates the content ratio (mol %) of (Ic) to all the monomer units, and is 0.1 to 10 mol % (expression (2)). If the content ratio c is less than 0.1 mol %, the modified EVOH (A) is insufficient in solution stability. The content ratio c is preferably 0.3 mol % or more, more preferably 0.5 mol % or more, even more preferably 0.8 mol % or more, and particularly preferably 1.0 mol % or more, and even 1.2 mol % or more is preferable in some cases. If the content ratio c is more than 10 mol %, on the other hand, the resulting film has lowered strength. The content ratio c is preferably 9 mol % or less, more preferably 8 mol % or less, even more preferably 7 mol %, and particularly preferably 5 mol % or less, and even 4 mol % or less or 3 mol % or less is preferable in some cases.

In the modified EVOH (A), b indicates the content ratio (mol %) of (Ib) to all the monomer units, and b satisfies the expression (3). If b does not satisfy the expression (3), the coating film to be given by application has insufficient gas barrier properties. b preferably satisfies expression (3′) shown below, and more preferably satisfies expression (3) shown below. If X groups in the formula (Ib) are two or more functional groups selected from the group consisting of a hydrogen atom, a formyl group, and an alkanoyl group having 2 to 10 carbon atoms (i.e., if a vinyl alcohol unit and a vinyl ester unit are simultaneously contained), b is the sum total of them.

$$[ 100 - ( a + c ) ] \times 0.95 \leq b \leq [ 100 - ( a + c ) ] \qquad ( {3}^{′} )$$

$$[ 100 - ( a + c ) ] \times 0.98 \leq b \leq [ 100 - ( a + c ) ] \qquad ( {3}^{″} )$$

Degree of saponification (DS) is defined as the expression (4), and the modified EVOH (A) has a degree of saponification (DS) of 90 mol % or more. Here, the “total number of moles of hydrogen atoms among X, Y, and Z groups” indicates the number of moles of hydroxy groups, and the “total number of moles of X, Y, and Z groups” indicates the total number of moles of hydroxy groups and ester groups. If the degree of saponification (DS) is less than 90 mol %, sufficient barrier performance is not obtained, the thermal stability of the modified EVOH (A) is insufficient, and gels and hard spots are frequently generated in melt-kneading for recycling. In addition, the lowered thermal stability tends to result in lowered long-run moldability in high-temperature molding. The degree of saponification (DS) is preferably 95 mol % or more, more preferably 98 mol % or more, and even more preferably 99 mol % or more. For achieving particularly excellent barrier properties and thermal stability, the degree of saponification (DS) is preferably 99 mol % or more, more preferably 99.5 mol % or more, and even more preferably 99.8 mol % or more. The degree of saponification (DS) is normally 100 mol % or less.

The degree of saponification (DS) can be determined by nuclear magnetic resonance (NMR). The content ratios of the monomer units, a, b, and c, can also be determined by NMR. The modified EVOH (A) to be used in the present invention is typically a random copolymer. Being a random copolymer can be confirmed from measurement results for NMR and melting point.

The melt flow rate (MFR) of the modified EVOH (A) (190° C., under a load of 2160 g) is preferably 0.1 to 30 g/10 min, more preferably 0.3 to 25 g/10 min, and even more preferably 0.5 to 20 g/10 min. Here, in the case that the melting point is around 190° C. or over 190° C., the MFR is defined as follows: measurement is performed at multiple temperatures equal to or higher than the melting point under a load of 2160 g, the reciprocal of absolute temperatures and the logarithm of MFRs are plotted on abscissa and ordinate, respectively, in a semilogarithmic graph, and a value obtained by extrapolation to 190° C. is employed as the MFR. If the MFR is less than 0.1 g/10 min, the viscosity of the solution is excessively high to the solid content concentration, resulting in failure in giving a coating film having a required thickness by single application, and leading to insufficient gas barrier properties and lowered productivity due to need of multiple applications. If the MFR is more than 30 g/10 min, the viscosity of the solution is excessively low to the solid content concentration, causing large thickness variation in the resulting coating film even when the viscosity difference of the solution is slight, and resulting in failure in imparting stable gas barrier properties to a packaging material.

### [Production of Modified EVOH (A)]

Subsequently, production of the modified EVOH (A) will be described. The structural unit (Ib), which contains X, is typically obtained by saponifying a vinyl ester. Accordingly, X is a saponifiable functional group or a functional group generated through saponification, and a specific example of X groups is a mixture of a hydrogen atom and a formyl group or an alkanoyl group having 2 to carbon atoms. In view of the availability of the monomer (vinyl acetate) and production cost, it is more preferable that X groups be a mixture of a hydrogen atom and an acetyl group.

The structural unit (Ic), which contains Y and Z, can be produced by copolymerizing monomers having an ester group such as unsaturated monomers having 1,3-diester structure and then saponifying the resultant, and can also be produced by directly copolymerizing monomers having a hydroxy group such as unsaturated monomers having 1,3-diol structure. Accordingly, Y groups, as well as Z groups, may be each a hydrogen atom, or be a mixture of a hydrogen atom and a formyl group or an alkanoyl group having 2 to 10 carbon atoms, more preferably a mixture of a hydrogen atom and an acetyl group.

The modified EVOH (A) may contain a structural unit derived from an additional ethylenically unsaturated monomer copolymerizable with a vinyl ester represented by formula (V) or an unsaturated monomer represented by formula (VI) or (VII), which are described later, unless the advantageous effects of the present invention are not inhibited. Examples of such additional ethylenically unsaturated monomers include: α-olefins such as propylene, n-butene, isobutylene, and 1-hexene; acrylic acid and salts thereof; unsaturated monomers having an acrylate group; methacrylic acid and salts thereof; unsaturated monomers having a methacrylate group; acrylamide, N-methylacrylamide, N-ethylacrylamide, N,N-dimethylacrylamide, diacetoneacrylamide, acrylamidepropanesulfonic acid and salts thereof, and acrylamidepropyldimethylamine and salts thereof (e.g., quaternary salts); methacrylamide, N-methylmethacrylamide, N-ethylmethacrylamide, methacrylamidepropanesulfonic acid and salts thereof, and methacrylamidepropyldimethylamine and salts thereof (e.g., quaternary salts); vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, stearyl vinyl ether, and 2,3-diacetoxy-1-vinyloxypropane; vinyl cyanides such as acrylonitrile and methacrylonitrile; vinyl halides such as vinyl chloride and vinyl fluoride; vinylidene halides such as vinylidene chloride and vinylidene fluoride; allyl compounds such as allyl acetate, 2,3-diacetoxy-1-allyloxypropane, and allyl chloride; unsaturated dicarboxylic acids such as maleic acid, itaconic acid, and fumaric acid and salts or esters thereof; vinylsilane compounds such as vinyltrimethoxysilane; an isopropenyl acetate.

Production of the modified EVOH (A) to be used in the present invention is not limited to a particular production method, and an exemplary production method is a method of subjecting ethylene, a vinyl ester represented by formula (V) shown below, and an unsaturated monomer represented by formula (VI) shown below to radical polymerization to give a copolymer and then saponifying the copolymer:

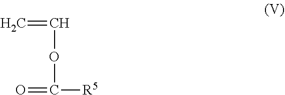

In the formula (V), R⁵ represents a hydrogen atom or an alkyl group having 1 to 9 carbon atoms. Examples of the vinyl ester represented by the formula (V) include vinyl formate, vinyl acetate, vinyl propionate, vinyl butyrate, vinyl isobutyrate, vinyl pivalate, vinyl versatate, and vinyl caproate. Vinyl acetate is more preferred from the economic point of view.

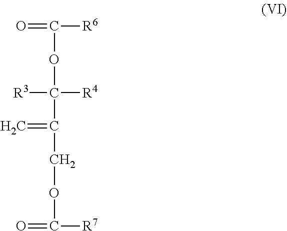

In the formula (VI), R³ and R⁴ are each as defined for the structural unit (IIc). R⁶ and R⁷ each independently represent a hydrogen atom or an alkyl group having 1 to 9 carbon atoms. Examples of the unsaturated monomer represented by the formula (VI) include 2-methylene-1,3-propanediol diacetate, 2-methylene-1,3-propanediol dipropionate, and 2-methylene-1,3-propanediol dibutyrate. Especially, 2-methylene-1,3-propanediol diacetate is preferably used for easiness in production. In the case of 2-methylene-1,3-propanediol diacetate, R³ and R⁴ are each a hydrogen atom, and R⁶ and R⁷ are each a methyl group.

An unsaturated monomer represented by formula (VII) shown below may be copolymerized in place of the unsaturated monomer represented by the formula (VI); in this case, only vinyl ester units containing R⁵ are saponified through saponification treatment.

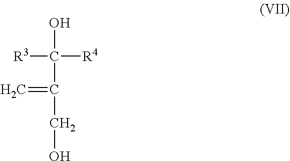

In the formula (VII), R³ and R⁴ are each as defined for the structural unit (IIc). Examples of the unsaturated monomer represented by the formula (VII) include 2-methylene-1,3-propanediol and 2-methylene-1,3-butanediol.

The unsaturated monomers represented by the formulas (VI) and (VII) have high copolymerization reactivity with vinyl ester monomers, and hence the copolymerization reaction smoothly proceeds. Accordingly, it is easy to achieve a higher modification level or degree of polymerization in the resulting modified ethylene-vinyl ester copolymer. In addition, even if the polymerization reaction is terminated at a low polymerization ratio, small amounts of unreacted parts of the unsaturated monomers are left at the end of polymerization, hence being excellent in terms of both environmental concerns and cost. In this regard, the unsaturated monomers represented by the formulas (VI) and (VII) are superior to other monomers having only one carbon atom having a functional group at an allyl position such as allyl glycidyl ether and 3,4-diacetoxy-1-butene. It is noted that the unsaturated monomer represented by the formula (VI) is more reactive than the unsaturated monomer represented by the formula (V).

The manner of polymerization in producing the modified ethylene-vinyl ester copolymer by copolymerizing ethylene, the vinyl ester represented by the formula (V), and the unsaturated monomer represented by the formula (VI) or (VII) may be any of batch polymerization, semi-batch polymerization, continuous polymerization, and semi-continuous polymerization. Any known polymerization method can be employed such as a bulk polymerization method, a solution polymerization method, a suspension polymerization method, and an emulsion polymerization method. The bulk polymerization method or solution polymerization method, in which polymerization is allowed to proceed without any solvent or in a solvent such as an alcohol, is typically employed. Employing the emulsion polymerization method is an option for obtaining a modified ethylene-vinyl ester copolymer having a high degree of polymerization.

Examples of the solvent to be used in the solution polymerization method include, but are not limited to, alcohols, and lower alcohols such as methanol, ethanol, and propyl alcohol are more preferred. Selection can be made for the amount of usage of the solvent in the polymerization reaction solution in view of a target viscosity-average degree of polymerization for the modified EVOH (A) and chain transfer to the solvent, and the weight ratio between the solvent contained in the reaction solution and all monomers (solvent/all monomers) is typically in the range of 0.01 to 10, preferably in the range of 0.03 to 3, and even more preferably in the range of 0.05 to 1.

Depending on the polymerization method, a polymerization initiator for use in copolymerizing ethylene, the vinyl ester represented by the formula (V), and the unsaturated monomer represented by the formula (VI) or (VII) is selected from known polymerization initiators such as azo initiators, peroxide initiators, and redox initiators. Examples of the azo initiators include 2,2′-azobisisobutyronitrile, 2,2′-azobis(2,4-dimethylvaleronitrile), and 2,2′-azobis(4-methoxy-2,4-dimethylvaleronitrile). Examples of the peroxide initiators include: percarbonate compounds such as diisopropyl peroxydicarbonate, di-2-ethylhexyl peroxydicarbonate, and diethoxyethyl peroxydicarbonate; perester compounds such as t-butyl peroxyneodecanoate, α-cumyl peroxyneodecanoate, and acetyl peroxide; acetylcyclohexylsulfonyl peroxide; and 2,4,4-trimethylpentyl-2-peroxyphenoxyacetate. Potassium persulfate, ammonium persulfate, hydrogen peroxide, or the like may be combined with any of the initiators. The redox initiators are each a polymerization initiator, for example, as a combination of any of the peroxide initiators and a reducing agent such as sodium hydrogen sulfite, sodium hydrogen carbonate, tartaric acid, L-ascorbic acid, and rongalite. The amount of usage of the polymerization initiator is adjusted according to the polymerization speed. The amount of usage of the polymerization initiator is preferably 0.01 to 0.2 mol, and more preferably 0.02 to 0.15 mol to 100 mol of the vinyl ester monomer. The polymerization temperature is not limited, whereas a temperature of room temperature to about 150° C. is appropriate, and the polymerization temperature is preferably 40° C. or more and 100° C. or less.

Ethylene, the vinyl ester represented by the formula (V), and the unsaturated monomer represented by the formula (VI) or (VII) may be copolymerized in the presence of a chain transfer agent, unless the advantageous effects of the present invention are not inhibited. Examples of the chain transfer agent include: aldehydes such as acetaldehyde and propionaldehyde; ketones such as acetone and methyl ethyl ketone; mercaptans such as 2-hydroxyethanethiol; and phosphinates such as sodium phosphinate monohydrate. Especially, aldehydes and ketones are preferred. The amount of the chain transfer agent to be added to the polymerization reaction solution is determined according to the chain transfer coefficient of the chain transfer agent and a target degree of polymerization for the modified ethylene-vinyl ester copolymer, typically, being preferably 0.1 to 10 parts by weight to 100 parts by weight of the vinyl ester monomer.

After polymerization is performed for a specific time and a specific polymerization ratio is reached, a polymerization inhibitor is added, as necessary, unreacted ethylene gas is removed by evaporation, and unreacted vinyl ester and the unsaturated monomer represented by the formula (VI) or (VII) are then removed. For flushing them out, for example, the following method is employed: the polymerization solution removed of ethylene is continuously fed at a constant rate from an upper part of a column packed with Raschig rings, a vapor of an organic solvent, preferably an alcohol having a boiling point of 100° C. or less, optimally methanol, is blown from a lower part of the column, the mixed vapor of the organic solvent and the unreacted vinyl ester, etc., is distilled off from the top of the column, and the copolymer solution removed of the unreacted vinyl ester, etc., is taken out from the bottom of the column.

An alkali catalyst is added to the copolymer solution removed of the unreacted vinyl ester, etc., to saponify the vinyl ester component in the copolymer. Both continuous and batch saponification methods are applicable. For the alkali catalyst, for example, sodium hydroxide, potassium hydroxide, or an alkali metal alcholate is used. Methanol is preferred as a solvent for the saponification. For example, conditions for the saponification are as follows.
(1) Concentration of ethylene-vinyl ester copolymer in solution: 10 to 50% by weight
(2) Reaction temperature: 30 to 150° C.
(3) Amount of usage of catalyst: 0.005 to 0.6 equivalents (per vinyl ester component)
(4) Time (average residence time for continuous mode): 10 minutes to 6 hours

Generally, saponification in a continuous mode allows more efficient removal of methyl acetate that is generated through the saponification, and hence gives a resin having a high degree of saponification with a smaller amount of a catalyst than saponification in a batch mode does. In addition, saponification in a continuous mode needs to be performed at higher temperature to prevent the precipitation of an EVOH that is generated through the saponification. Accordingly, it is preferable for saponification in a continuous mode to employ a reaction temperature and an amount of a catalyst within the following ranges.

Reaction temperature: 70 to 150° C.

Amount of usage of catalyst: 0.005 to 0.1 equivalents (per vinyl ester component)

Saponification of the modified ethylene-vinyl ester copolymer in that way gives a solution or paste containing the modified EVOH (A). At that time, vinyl ester units in the copolymer are converted into vinyl alcohol units. In addition, ester bonds derived from the unsaturated monomer represented by the formula (VI) are simultaneously hydrolyzed and converted into 1,3-diol structures. Thus, ester groups of different types can be simultaneously hydrolyzed through one saponification reaction.

The modified EVOH (A) after the saponification reaction contains the alkali catalyst, byproduct salts such as sodium acetate and potassium acetate, and other impurities, and they may be removed by neutralization and washing, as necessary. Here, in washing the modified EVOH (A) after the saponification reaction with ion-exchange water or the like almost free of metal ions, chloride ions, and so on, a catalyst residue such as sodium acetate and potassium acetate may partially remain in the modified EVOH (A).

The thus-obtained solution or paste containing the modified EVOH (A) typically contains 50 parts by weight or more of an alcohol to 100 parts by weight of the EVOH. The alcohol is preferably methanol.

Washing of and adjustment of the water content of the solution or paste containing the modified EVOH (A) are not limited to particular methods, and can be performed as follows. Water is added to the solution or paste containing the modified EVOH (A) with heating and stirring, and an alcohol is distilled off to precipitate the modified EVOH (A). Preferably, the temperature at that time is 50 to 100° C. The precipitated modified EVOH (A) is washed with water, aqueous solution of acetic acid, or the like. Preferably, the temperature at that time is 5 to 50° C. The modified EVOH after washing is dried, as necessary. For example, the modified EVOH is dried at 50 to 100° C. for 1 to 24 hours. The water content of the modified EVOH (A) can be adjusted through the washing conditions and drying conditions.

### <Other Components Contained in Modified EVOH (A)>

It is preferred for the modified EVOH (A) to contain an alkali metal ion. Inclusion of an alkali metal ion in the modified EVOH (A) gives enhanced adhesion between adjacent layers in forming a multilayer structure, and as a result the gas barrier properties before bending can be maintained after bending.

The lower limit of the alkali metal ion content (the alkali metal ion content of the dried product) is preferably 2.5 μmol/g, more preferably 3.5 μmol/g, and even more preferably 4.5 μmol/g. The upper limit of the alkali metal ion content is preferably 22 μmol/g, more preferably 16 μmol/g, and even more preferably 10 μmol/g. With the metal ion content being higher than the lower limit, higher interlayer adhesion is given, and the gas barrier properties before bending can be maintained after bending. With the alkali metal ion content being lower than the upper limit, the generation of gels in melt-extrusion can be prevented.

Examples of the alkali metal ion include lithium, sodium, potassium, rubidium, and cesium ions, and a sodium or potassium ion is more preferred in terms of industrial availability.

Examples of alkali metal salts that give an alkali metal ion include, but are not limited, aliphatic carboxylates, aromatic carboxylates, phosphates, and metal complexes of lithium, sodium, or potassium. Specific examples of such alkali metal salts include sodium acetate, potassium acetate, sodium phosphate, lithium phosphate, sodium stearate, potassium stearate, and sodium ethylenediaminetetraacetate. Among them, sodium acetate, potassium acetate, and sodium phosphate are particularly preferred because they are readily available.

It is also preferred for the modified EVOH (A) to contain an alkaline earth metal ion. Examples of the alkaline earth metal ion include beryllium, magnesium, calcium, strontium, and barium ions, and a magnesium or calcium ion is more preferred in terms of industrial availability. Inclusion of an alkaline earth metal ion in the modified EVOH (A) reduces defects such as gels and hard spots, leading to enhanced recyclability.

Unless the purpose of the present invention is inhibited, the modified EVOH (A) can be blended with a thermal stabilizer, an antioxidant, or inorganic microparticles for use.

Among inorganic microparticles, those of amorphous silica develop anti-blocking effect and function to enhance the gas barrier properties of the modified EVOH (A), thus being preferred. The amount of inorganic microparticles to be added is preferably 10 to 10,000 ppm, more preferably 100 to 3,000 ppm, and optimally 500 to 1,500 ppm.

### [Coating Agent]

The coating agent of the present invention comprises the modified EVOH (A). Any solvent that can dissolve the modified EVOH (A) therein can be used for the coating agent of the present invention without limitation, and an alcohol such as methanol, ethanol, propyl alcohol, and butyl alcohol, a dialkyl sulfoxide such as dimethyl sulfoxide, an amide such as dimethylformamide, N-methylpyrrolidone, or a mixed solvent of any of them and water is preferably used.

Especially, use of a mixed solvent of an alcohol and water is particularly preferred from the viewpoints of solubility and economic efficiency. Aliphatic alcohols having 4 or less carbon atoms are preferred as the alcohol to be used at that time with respect to solubility, dissolution temperature, volatility (drying speed), economic efficiency, and so on. Among aliphatic alcohols having 4 or less carbon atoms, n-propyl alcohol, isopropyl alcohol, n-butyl alcohol, sec-butyl alcohol, and tert-butyl alcohol are particularly preferably used, and n-propyl alcohol is the optimum. Here, two or more of those alcohols may be used at the same time.

The blend ratio between the alcohol and water in the mixed solvent is not limited, and appropriately adjusted according to the type of the alcohol, the composition of the modified EVOH (A), the concentration of the modified EVOH (A), coating conditions (e.g., temperature), the application, and others. The alcohol content of the mixed solvent is normally 1 to 99% by weight. From the viewpoint of solubility and storage stability in solution, the alcohol content of the mixed solvent is preferably 40% by weight or more, and more preferably 50% by weight or more. For the same reason, the alcohol content of the mixed solvent is preferably 90% by weight or less, and more preferably 80% by weight or less. Here, it is preferable that the component other than the alcohol in the mixed solvent be water.

Preferably, the coating agent of the present invention has a content of the modified EVOH (A) of 1 to 50% by weight. If the content is lower than 1% by weight, the increased amount of usage of the solvent leads to an economic disadvantage, and may make it difficult to give a large application thickness. The content is more preferably 5% by weight or more, and even more preferably 10% by weight or more. Because the modified EVOH (A) is less likely to crystallize and shows good storage stability even at a relatively high concentration, use of the modified EVOH (A) in a high-concentration solution is preferred. If the content of the modified EVOH (A) is more than 50% by weight, on the other hand, the solution viscosity is excessively high, which may lead to difficulty in application and result in insufficient storage stability in solution. The content is more preferably 40% by weight or less, and even more preferably 30% by weight or less.

The coating agent of the present invention may comprise, together with the modified EVOH (A), an ethylene-vinyl alcohol copolymer (B) other than the modified EVOH (A). The ethylene-vinyl alcohol copolymer (B) does not contain the structural unit (Ic), and contains the structural units (1a) and (1b). Preferably, the ethylene-vinyl alcohol copolymer (B) is an unmodified EVOH (hereinafter, occasionally abbreviated as the unmodified EVOH (B)). For the unmodified EVOH (B) to be used here, appropriate one according to the composition of the modified EVOH (A) and the application is selected, and blending the unmodified EVOH (B) can result in an increased degree of freedom of selection and blend of additional additives without impairing the gas barrier properties of a coating film to be given.

In the case that the coating agent of the present invention comprises the unmodified EVOH (B), a coating film having good barrier properties and appearance is given if the unmodified EVOH (B) has an ethylene content of 21 to 65 mol %. The ethylene content of the unmodified EVOH (B) is preferably 25 mol % or more and more preferably 28 mol % or more, and 30 mol % or more, 35 mol % or more, 40 mol % or more, or 45 mol % or more is preferred in some cases. The ethylene content of the unmodified EVOH (B) is preferably 60 mol % or less, and 58 mol % or less or 55 mol % or less is preferred in some cases.

In the case that the coating agent of the present invention comprises the unmodified EVOH (B), the total content of the modified EVOH (A) and the unmodified EVOH (B) is preferably 1 to 50% by weight to the total weight of the coating agent. If the total content is less than 1% by weight, the increased amount of usage of the solvent leads to an economic disadvantage, and may make it difficult to give a large application thickness. The total content is more preferably 5% by weight or more, and even more preferably 10% by weight or more. If the total content is more than 50% by weight, on the other hand, the solution viscosity is excessively high, which may lead to difficulty in application and result in insufficient storage stability in solution. The total content is more preferably 40% by weight or less, and even more preferably 30% by weight or less.

In the case that the coating agent of the present invention contains the unmodified EVOH (B), the weight ratio (A/B) between the modified EVOH (A) and the unmodified EVOH (B) is typically 1/99 to 99/1. The weight ratio (A/B) is preferably 90/10 or less, and more preferably 80/20 or less. Improved storage stability in solution can be achieved by blending the modified EVOH (A).

In the case that the coating agent of the present invention comprises a mixture of two or more different modified EVOHs (A) as the modified EVOH (A), or comprises the modified EVOH (A) and the unmodified EVOH (B), average values calculated from the weight ratio for blending are used for the content ratios of the structural units, the degree of saponification, and the MFR.

Unless the purpose of the present invention is inhibited, the coating agent may comprise a boron compound. Here, examples of the boron compound include boric acids, boric acid esters, boric acid salts, and boron hydrides. Specific examples of the boric acids include orthoboric acid, metaboric acid, and tetraboric acid; examples of the boric acid esters include triethyl borate and trimethyl borate; examples of the boric acid salts include alkali metal salts and alkaline earth metal salts of any of the boric acids, and borax. Among these compounds, orthoboric acid (hereinafter, occasionally expressed as boric acid, simply) is preferred.

If a boron compound is used, the boron compound content of the coating agent is preferably 20 to 2000 ppm, and more preferably 50 to 1000 ppm in terms of boron element to the amount of the modified EVOH (A). Further improved storage stability in solution is achieved by blending a boron compound within that range. Alternatively, an EVOH with a boron compound blended therein can be used as the modified EVOH (A). In this case, the boron compound content of the modified EVOH (A) is preferably 20 to 2000 ppm, and more preferably 50 to 1000 ppm in terms of boron element.

Unless the purpose of the present invention is inhibited, the coating agent may comprise a phosphoric acid compound. Thereby, the quality of resin (e.g., coloring) can be stabilized in some cases. Any phosphoric acid compound is applicable to the present invention without limitation, and various acids such as phosphoric acid and phosphorous acid and salts thereof can be used. A phosphate contained in the coating agent may be in any form of monobasic phosphate, dibasic phosphate, and tribasic phosphate, and monobasic phosphate is preferred. The cationic species is not limited, and an alkali metal salt is preferred. Among such compounds, sodium dihydrogen phosphate and potassium dihydrogen phosphate are preferred. In the case that a modified EVOH (A) with a phosphoric acid compound blended therein is used, the phosphoric acid compound content of the modified EVOH (A) is preferably 200 ppm or less, more preferably 5 to 100 ppm, and even more preferably 5 to 50 ppm in terms of phosphoric acid radicals.

Unless the purpose of the present invention is inhibited, the coating agent may comprise inorganic microparticles. The inorganic microparticles are preferably inorganic oxide particles, and more preferably silicon oxide particles or metal oxide particles. The metal constituting the metal oxide particles is preferably at least one selected from the group consisting of aluminum, magnesium, zirconium, cerium, tungsten, molybdenum, titanium, and zinc. Specific examples of the inorganic oxide constituting the inorganic oxide particles can include silicon oxide, aluminum oxide, zirconium oxide, magnesium oxide, cerium oxide, tungsten oxide, molybdenum oxide, titanium oxide, zinc oxide, and composites of them, and silicon oxide is preferred. Of silicon oxide, amorphous silica is particularly preferred. One inorganic oxide alone or a combination of two or more inorganic oxides may be used. Among inorganic microparticles, amorphous silica particles are particularly preferred because they develop anti-blocking effect and function to enhance the gas barrier properties of the modified EVOH (A). The inorganic microparticle content of the coating agent is preferably 10 to 10,000 ppm, more preferably 300 to 10,000 ppm, even more preferably 500 to 3,000 ppm, and still even more preferably 700 to 1,500 ppm. The average particle size of the inorganic microparticles dispersed in solution is 0.1 to 30 m. If the average particle size is less than 0.1 μm, the resulting coating film is insufficient in slipperiness. The average particle size is preferably 1 μm or more, and more preferably 2 m or more. If the average particle size is more than 30 μm, the resulting film has hard spots, thus being poor in appearance. The average particle size is preferably 10 μm or less.

Various additives can be blended in the coating agent of the present invention, as necessary. Examples of such additives can include surfactants, antioxidants, plasticizers, thermal stabilizers, ultraviolet absorbers, antistatic agents, lubricants, coloring agents, fillers, soluble inorganic salts, and other polymer compounds, and these can be blended in such a manner that the operations and effects of the present invention are not inhibited.

Any means such as discharge from a casting head, roll coating, doctor knife coating, spray coating/dipping, and blush application can be employed as a method for coating various substrates with the coating agent of the present invention. After coating, the coating film is dried and further heat-treated, as necessary. Although the conditions for drying depend on, for example, the thickness of the coating film, a temperature of 50 to 130° C. and a time of 10 seconds to 10 minutes are preferred. A temperature of 100 to 150° C. and a time of 10 seconds to 10 minutes are preferred as the conditions for heat treatment. The thickness of the coating film (on dry basis) is preferably 0.5 to 20 μm, and more preferably 1 to 15 μm. If the thickness is 0.5 μm or less, sufficient gas barrier properties may not be given, if the thickness is more than 20 μm, on the other hand, operations including an increased cycles of application are needed to give a coating film of desired thickness, and this may lead to lowered productivity.

The storage stability in solution is checked on the basis of two indexes: viscosity stability and stability of transparency.

If there is a viscosity change after storage of an EVOH solution, the viscosity change may cause thickness variation in coating. For example, if the solution has undergone large viscosity reduction during 1-week continuous coating, the resulting coating film has a smaller thickness and the multilayer structure has lower gas barrier properties. Accordingly, an EVOH solution that undergoes a small viscosity change in storing the solution is preferred. From this viewpoint, when a solution of the modified EVOH (A) is stored under an environment at 20° C. for 7 days, the change rate |(V7−V₀)/V₀| of the solution viscosity after the storage for 7 days, V7 (cP), to the initial solution viscosity before the storage, V₀ (cP), is preferably 50% or less, more preferably 30% or less, even more preferably 20% or less, and most preferably 10% or less.

If there is reduction in the transparency (light transmittance) of an EVOH solution after storing the solution, EVOH microparticles that cause light scattering have been generated in the solution. Generation of such EVOH microparticles causes failure in giving a homogeneous coating film, resulting in lowered gas barrier properties and light transmittance. Accordingly, the difference (T₀−T₇) between the light transmittance of a solution of the modified EVOH (A) as measured at a wavelength of 800 nm for an optical path length of 1 cm at 20° C. immediately after preparation of the solution, T₀, and the light transmittance of the solution stored at 20° C. for 1 week as measured under the same conditions, T₇, is normally 99% or less, preferably 25% or less, more preferably 20% or less, even more preferably 10% or less, and particularly preferably 5% or less, and substantially no change is most preferred.

Being excellent in storage stability, the coating agent of the present invention is less likely to become cloudy even when stored for a long period of time from preparation of a solution to coating with it. Accordingly, the coating agent allows transport under room temperature, and does not need an operation of heating immediately before coating in normal cases. The resulting coating film is excellent in transparency, gas barrier properties, and flexibility. By contrast, a solution of an unmodified EVOH often becomes cloudy during storage. If the resultant is directly applied, the resulting coating film has significantly lowered gas barrier properties, as well as fogging.

### [Multilayer Structure Formed by Applying the Coating Agent on Substrate]

Examples of substrates onto which the coating agent of the present invention is applied include, but are not limited to, those of resin, metal, paper, and wood. Especially, a substrate consisting of resin, in particular, of thermoplastic resin is preferred. Examples of such thermoplastic resins include polyolefin, polyamide, polyester, polystyrene, polyvinyl chloride, poly(meth)acrylate, polyvinylidene chloride, polyacetal, polycarbonate, polyvinyl acetate, polyurethane, and polyacrylonitrile. Various copolymers are also applicable. By applying the coating agent of the present invention onto such a substrate, a multilayer structure having a layer consisting of the modified EVOH (A) on a surface of which is formed. The thickness of the layer consisting of the modified EVOH (A) (the thickness of the coating film) is as described above.

In coating the substrate with the coating agent of the present invention, it is preferable for ensuring the adhesion between a face of the substrate and the layer formed by applying the coating agent to perform physical treatment such as corona treatment for the coating face of the substrate (e.g., in the case that the substrate is a film or the like consisting of polyolefin such as polyethylene, the treatment is performed to give a surface tension of 37 to 45 dyne/cm or so to the substrate) or apply a polyurethane anchor coat agent onto the coating face of the substrate.

A multilayer structure formed by applying the coating agent of the present invention onto any of those various substrates is a preferred embodiment of the coating agent of the present invention. The resulting multilayer structure is excellent in gas barrier properties, fragrance retention properties, and oil resistance, and used for a wide range of fields. In particular, the multilayer structure can be preferably used for a packaging material (a film, a sheet, a container, etc.) to contain a food, a beverage, a chemical product, a pharmaceutical product, or the like as its content. Because the coating film given by coating and the multilayer structure including the coating film are excellent in flexibility and flex resistance, a multilayer structure formed by applying the coating agent of the present invention onto a flexible substrate such as a film and a sheet is particularly useful, and preferably used, for example, as a flexible pouch. Because the coating film given by coating is also excellent in stretchability, it is also preferable to subject a product given by coating a substrate with the coating agent to a subsequent stretching operation. The thus-obtained multilayer structure is preferably used, for example, as a stretched film or a thermoformed container. In addition, the coating agent of the present invention is useful as a surface-coating material for wallpapers, card cases, desk mats, and others consisting of soft polyvinyl chloride resin containing a plasticizer. Such a coating material has functions to prevent the bleeding of the plasticizer from the soft polyvinyl chloride resin and further prevent surface staining.

### [Multilayer Structure Comprising Paper Layer and Layer Consisting of Modified EVOH (A)]

A multilayer structure comprising a paper layer and a layer consisting of the modified EVOH (A) (hereinafter, occasionally abbreviated as “the modified EVOH (A) layer”) is preferably used as a package, which is described later, or the like. Such a multilayer structure can also be produced with the above-described coating agent of the present invention. The modified EVOH (A) layer can be formed by applying the coating agent onto a paper substrate to form the paper layer.

The multilayer structure may be composed only of the paper layer and the modified EVOH (A) layer, and may comprise an additional layer other than the paper layer and the modified EVOH (A) layer, the additional layer is described later. For maintaining the paper recyclability, it is preferable that the modified EVOH (A) layer and an additional layer be disposed only on one side of the paper layer. For imparting good gas barrier properties, on the other hand, the modified EVOH (A) layer and an additional layer may be disposed on each side of the paper layer. The gas barrier properties of the multilayer structure can be evaluated on the basis of measurements of oxygen transmission rates, specifically, with a method described in Examples.

### <Gas Barrier Properties>

Gas barrier properties are functions to prevent the transmission of gasses, and are indicated as, for example, an oxygen transmission rate (OTR) as measured under conditions of 20° C. and 65% RH in accordance with JIS-K7126-2 (2006) Part 2 (Equal-pressure method). Here, an oxygen transmission rate of “20 cc/(m²·day·atm)” means that the amount of oxygen transmitted per unit area of a multilayer structure in a day is 20 cc at 1 atm. The upper limit of the oxygen transmission rate of the multilayer structure comprising the paper layer and the modified EVOH (A) layer is preferably 20 cc/m²·day·atm or less, more preferably 10 cc/m²·day·atm or less, even more preferably 5 cc/m²·day·atm or less, and preferably 1 cc/m²·day·atm. If the oxygen transmission rate is equal to or less than the upper limit, the oxidation degradation of contents is reduced when the multilayer structure is used as a package, and thus further enhanced storability is achieved.

### <Gas Barrier Properties Before and After Bending>

When a multilayer structure is processed to produce a package, the multilayer structure may be bent. In the case of a multilayer structure including a paper layer, an excessive stress is applied to a bent part, and the other layer(s) may be cracked. When the package with a content put therein is stored, such cracks generated in the package lower the gas barrier properties to deteriorate the content. Accordingly, for a package produced with the multilayer structure comprising a paper layer and a layer consisting of the modified EVOH (A) with a bent part at a bending angle of 360°, the ratio (OTR2/OTR1) of the oxygen transmission rate of a cut-out part including the bent part at the center (OTR2) to the oxygen transmission rate of a cut-out part including no bent part (OTR1) is preferably less than 10, more preferably less than 5, and even more preferably less than 3.

### <Heat-Seal Strength>

If the heat-seal strength of a package is good, the resulting enhanced sealability allows its content to be protected from degradation or the like caused by oxidation due to oxygen, humidity, and so on, successfully giving prolonged storage period. For example, the heat-seal strength of the multilayer structure is measured at a width of 15 mm in accordance with JIS Z 0238. The heat-seal strength of the multilayer structure is preferably 300 gf/15 mm or more, more preferably 500 gf/15 mm or more, even more preferably 800 gf/15 mm or more, and particularly preferably 1500 gf/15 mm or more. Having such a heat-seal strength, the multilayer structure can achieve enhanced sealability for its content as well as reduction in the frequency of damage of the package during distribution or the like, successfully giving prolonged storage period.

### <Paper Layer>

Examples of paper substrates that are used as the paper layer include a film or sheet containing pulp, a filling agent, a chemical agent, or a pigment. Examples of the pulp include: chemical pulp such as hardwood bleached kraft pulp (LBKP), softwood bleached kraft pulp (NBKP), hardwood unbleached kraft pulp (LUKP), softwood unbleached pulp (NUKP), and sulfite pulp; mechanical pulp such as stone-ground pulp and thermomechanical pulp; wood fiber such as deinked pulp and wastepaper pulp; and non-wood fiber obtained from kenaf, bamboo, hemp, or the like. One of these pulps alone or a combination of two or more thereof can be used. Among those, chemical pulp, mechanical pulp, and wood fiber are preferred, and chemical pulp is more preferred because the occurrence of contamination in base paper and the occurrence of temporal discoloration in recycling used paper containers for use are readily prevented, and a good surface feeling is likely to be given in printing.

Examples of the filling agent that is used for paper substrates include known filling agents such as white carbon, talc, kaolin, clay, heavy calcium carbonate, light calcium carbonate, titanium oxide, zeolite, and synthetic resin filling agents. One of the filling agents alone or a combination of two or more thereof can be used. Examples of the chemical agent include oxidized starch, hydroxyethyl-etherified starch, enzymatically modified starch, polyacrylamide, polyvinyl alcohol, a surface-sizing agent (e.g., a neutral sizing agent), a water-resistant agent, a humectant, a thickener, a lubricant, a yield improver, a filterability improver, and a paper strength enhancer, and one of these alone or a combination of two or more thereof may be used. Examples of the yield improver include aluminum sulfate and anionic, cationic, nonionic, and amphoteric yield improvers. Examples of dry paper strength enhancers include polyacrylamide and cationic starch, and examples of wet paper strength enhancers include polyamidoamine-epichlorohydrin. Those chemical agents are added in such a manner that the texture, operability, and others are not affected. Examples of neutral sizing agents include alkylketene dimer and alkenyl succinic anhydride, and neutral rosin sizing agents. Examples of the pigment include inorganic pigments such as kaolin, clay, engineered kaolin, delaminated clay, heavy calcium carbonate, light calcium carbonate, mica, talc, titanium dioxide, barium sulfate, calcium sulfate, zinc oxide, silicic acid, silicates, colloidal silica, and satin white; and solid, hollow or core-shell organic pigments; one of these alone or a combination of two or more thereof can be used. Furthermore, a dye, a fluorescent brightener, a pH adjuster, a defoamer, a pitch-controlling agent, a slime control agent, and so on can be added, as necessary. The surface of a paper substrate may be treated with any of the various chemical agents and pigments.

Any production (papermaking) method can be used for a paper substrate without limitation, and a paper substrate can be produced by papermaking with an acidic papermaking, neutral papermaking, or alkaline papermaking method using a known fourdrinier former, on-top hybrid former, gap former machine, or the like.

Any method of surface treatment can be used for a paper substrate without limitation, and a known coating apparatus can be used such as a rod metering size press, a pond size press, a gate roll coater, a spray coater, a blade coater, and a curtain coater.

Examples of paper substrates (base paper sheets) that are obtained in that manner include known paper substrates such as those of high-quality paper, ordinary grade paper, coated paper, machine-glazed paper, kraft paper, machine-glazed kraft paper, bleached kraft paper, unbleached kraft paper, rayon paper, thin paper, glassine paper, paperboard, white paperboard, cellophane, and linerboard.

The paper substrate may include a transparent coating layer as a part of the paper substrate on one or each face of a sheet of the above-described base paper. The formation of a transparent coating layer on the base paper sheet provides the base paper sheet with enhanced surface strength and smoothness. The applicability in applying a pigment is also enhanced. The transparent coating layer may contain a starch-derived polymer compound as a binder. The amount of a coating solution to be applied in forming the transparent coating layer is preferably 0.1 to 4.0 g/m², and more preferably 0.5 to 2.5 g/m² in terms of solid contents per one face. For example, a coating solution containing any type of starch such as starch and oxidized starch or a water-soluble polymer such as polyacrylamide and polyvinyl alcohol as a main component may be applied onto the base paper sheet with a coater (coating machine) such as a size press, a gate roll coater, a pre-metering size press, a curtain coater, and a spray coater. It is preferable for homogenization of a coating layer after application that the base paper sheet before application be subjected to pre-calender treatment with an online soft calender, an online chilled calender, or the like to smooth the base paper sheet in advance.

The paper substrate may be subjected to smoothing treatment, as necessary. For the smoothing treatment, a common smoothing apparatus can be used such as a super calender, a gross calender, a soft calender, a heat calender, and a shoe calender. The smoothing apparatus is used in an on-machine or off-machine mode as appropriate, and the form of the pressurizing machine, the number of pressurizing nips, heating, and so on are appropriately adjusted.

An appropriate basis weight can be selected for the paper substrate according to qualities desired for a package, handleability, and so on, typically, the basis weight of the paper substrate is preferably about 15 to 800 g/m². In the case of a packaging material, for example, for use in applications such as packages, bags, paper containers, cardboard boxes, and cups for foods and the like, the basis weight of the paper substrate is more preferably 25 to 600 g/m². Furthermore, the basis weight of the paper substrate is particularly preferably 30 to 150 g/m² for bags or soft packages described later, 170 to 600 g/m² for paper articles, 150 to 300 g/m² for cardboard liner, and 120 to 200 g/m² for corrugating media. If the basis weight of the paper substrate is equal to or less than the upper limit, enhanced heat-seal strength is achieved. If the basis weight of the paper substrate is equal to or more than the lower limit, enhanced mechanical strength is achieved and the frequency of troubles in production of packages is reduced.

### <Additional Layers>

It is preferable that the multilayer structure comprising a paper layer and a layer consisting of the modified EVOH (A) further comprise an intermediate layer or a sealant layer as an additional layer. In the case that an intermediate layer is comprised, it is preferable for reducing the lowering of the gas barrier properties after bending that the intermediate layer be directly laminated on the paper layer and the modified EVOH (A) layer be directly laminated on the intermediate layer. In the case that a sealant layer is comprised, it is preferable for enhancing the heat-seal strength of the multilayer structure that the sealant layer be disposed on the outermost layer side. Specific examples of the layer configuration of the multilayer structure are shown below. In the following, “/” indicates direct lamination and “//” indicates lamination via an adhesion layer:
paper layer/modified EVOH (A) layer;
modified EVOH (A) layer/paper layer/modified EVOH (A) layer;
modified EVOH (A) layer/paper layer/modified EVOH (A) layer/paper layer/modified EVOH (A) layer;
paper layer/intermediate layer/modified EVOH (A) layer;
paper layer/intermediate layer/modified EVOH (A) layer/sealant layer;
paper layer/intermediate layer/modified EVOH (A) layer//sealant layer;
modified EVOH (A) layer/intermediate layer/paper layer/modified EVOH (A) layer/paper layer/modified EVOH (A) layer;
modified EVOH (A) layer/intermediate layer/paper layer/modified EVOH (A) layer/paper layer/modified EVOH (A) layer/sealant layer;
modified EVOH (A) layer/intermediate layer/paper layer/modified EVOH (A) layer/paper layer/modified EVOH (A) layer//sealant layer;
modified EVOH (A) layer/intermediate layer/paper layer/intermediate layer/modified EVOH (A) layer/paper layer/modified EVOH (A) layer;
modified EVOH (A) layer/intermediate layer/paper layer/intermediate layer/modified EVOH (A) layer/paper layer/modified EVOH (A) layer/sealant layer;
modified EVOH (A) layer/intermediate layer/paper layer/intermediate layer/modified EVOH (A) layer/paper layer/modified EVOH (A) layer//sealant layer;
modified EVOH (A) layer/intermediate layer/paper layer/intermediate layer/modified EVOH (A) layer/paper layer/intermediate layer/modified EVOH (A) layer;
modified EVOH (A) layer/intermediate layer/paper layer/intermediate layer/modified EVOH (A) layer/paper layer/intermediate layer/modified EVOH (A) layer/sealant layer; and
modified EVOH (A) layer/intermediate layer/paper layer/intermediate layer/modified EVOH (A) layer/paper layer/intermediate layer/modified EVOH (A) layer//sealant layer.

### <Intermediate Layer>

The intermediate layer may be an anchor coat layer formed by applying an anchor coat agent and drying it or a thermoplastic resin layer formed by melt extrusion.

Examples of the anchor coat agent that is used for the formation of the intermediate layer include an anchor coat agent consisting of any resin having a heat resistant temperature of 135° C. or more such as vinyl modified resin, epoxy resin, urethane resin, and polyester resin; in particular, an anchor coat agent consisting of an acrylic or methacrylic resin having two or more hydroxyl groups in the structure and an isocyanate compound as a curing agent can be preferably used. In addition, a silane coupling agent may be used in combination therewith as an additive, and nitrocellulose may be used in combination for increased heat resistance.

It is preferable to use an adhesive resin containing a carboxylic acid-modified polyolefin having adhesiveness to the modified EVOH (A) for the thermoplastic resin layer as the intermediate layer. Preferably, a modified olefin polymer containing a carboxyl group obtained by chemically (e.g., through addition reaction, graft reaction) bonding an ethylenically unsaturated carboxylic acid or an ester or anhydride thereof to an olefin polymer can be used as the carboxylic acid-modified polyolefin. Examples of the olefin polymer include: polyolefins such as polyethylene (e.g., low-density polyethylene, medium-density polyethylene, high-density polyethylene), linear low-density polyethylene, polypropylene, and polybutene; and copolymers of an olefin and another monomer (e.g., vinyl ester, unsaturated carboxylate) such as ethylene-vinyl acetate copolymer and ethylene-ethyl acrylate copolymer. Linear low-density polyethylene, ethylene-vinyl acetate copolymer (vinyl acetate content: 5 to 55% by mass), and ethylene-ethyl acrylate copolymer (ethyl acrylate content: 8 to 35% by mass) are preferred, and liner low-density polyethylene and ethylene-vinyl acetate copolymer are particularly preferred. Examples of the ethylenically unsaturated carboxylic acid or ester or anhydride thereof include ethylenically unsaturated monocarboxylic acid or an ester thereof, and ethylenically unsaturated dicarboxylic acid or a mono- or diester or anhydride thereof; especially, ethylenically unsaturated dicarboxylic anhydride is preferred. Specific examples thereof include maleic acid, fumaric acid, itaconic acid, maleic anhydride, itaconic anhydride, monomethyl maleate, monoethyl maleate, diethyl maleate, and monomethyl fumarate; in particular, maleic anhydride is preferred.

The amount of the ethylenically unsaturated carboxylic acid or anhydride thereof to be added to or grafted onto the olefin polymer (degree of modification) is, for example, preferably 0.0001% by mass to 15% by mass, and more preferably 0.001% by mass to 10% by mass with respect to the amount of the olefin polymer. The addition reaction or graft reaction of the ethylenically unsaturated carboxylic acid or anhydride thereof to the olefin polymer can be performed, for example, by means of a radical polymerization method in the presence of a solvent (e.g., xylene) and a catalyst (e.g., a peroxide). The melt flow rate (MFR, under a load of 2160 g) of the thus-obtained carboxylic acid-modified polyolefin as measured at 210° C. is preferably 0.2 g/10 min to 30 g/10 min, and more preferably 0.5 g/10 min to 10 g/10 min. One of those adhesive resins alone or a mixture of two or more thereof may be used.

In the present invention, the lower limit of the average thickness of the intermediate layer is preferably 0.1 μm or more, more preferably 0.3 μm or more, and even more preferably 0.5 μm or more. If the average thickness is equal to or more than the lower limit, the lowering of the gas barrier properties after bending is further reduced. The upper limit of the average thickness is preferably 50 μm or less, more preferably 30 μm or less, and even more preferably 10 μm or less. If the average thickness is equal to or less than the upper limit, enhanced paper recyclability is achieved.

### <Sealant Layer>

The sealant layer may be a resin layer formed by applying a coat agent and drying it or a thermoplastic resin layer formed by melt extrusion.

Examples of the coat agent that is used for the formation of the sealant layer include a coat agent consisting of any resin having a heat resistant temperature of 135° C. or more such as vinyl modified resin, epoxy resin, urethane resin, and polyester resin, polylactic acid (PLA) resin, styrene-acrylate copolymer, polyolefin copolymer, and ethylene-methacrylate copolymer, in particular, an anchor coat agent consisting of an acrylic resin or methacrylic resin having two or more hydroxyl groups in the structure and an isocyanate compound as a curing agent can be preferably used. In addition, a silane coupling agent may be used in combination therewith as an additive, and nitrocellulose may be used in combination for increased heat resistance.

The thermoplastic resin constituting the sealant layer may be any resin that softens and exhibits plasticity on being heated to the glass transition temperature or the melting point without limitation, and examples thereof include polyolefin resin (polyethylene resin, polypropylene resin, etc.), grafted polyolefin resin obtained by graft-modified with an unsaturated carboxylic acid or an ester thereof, halogenated polyolefin resin, ethylene-vinyl acetate copolymer resin, ethylene-acrylic acid copolymer resin, ethylene-acrylate copolymer resin, polyester resin, polyamide resin, polyvinyl chloride resin, polyvinylidene chloride resin, acrylic resin, polystyrene resin, vinyl ester resin, ionomer, polyester elastomer, polyurethane elastomer, and aromatic or aliphatic polyketone. In particular, because of having good mechanical strength and molding processability, polyolefin resin is preferred, and polyethylene resin and polypropylene resin are more preferred.

The thermoplastic resin layer may contain an additive in such a manner that the purpose of the present invention is not impaired. Examples of the additive include a resin other than the thermoplastic resin, a thermal stabilizer, an ultraviolet absorber, an antioxidant, a coloring agent, and a filler. If the thermoplastic resin layer contains an additive other than the thermoplastic resin, the content ratio of the additive is preferably 20% by mass or less, more preferably 10% by mass or less, and even more preferably 5% by mass or less to the total amount of the thermoplastic resin layer.

The thermoplastic resin layer contains a thermoplastic resin as a main component. The thermoplastic resin layer may contain any of a single thermoplastic resin and a mixture of a plurality of thermoplastic resins as a main component.

The lower limit of the average thickness of the sealant layer is preferably 1 μm or more, more preferably 3 μm or more, and even more preferably 5 m or more. If the average thickness is equal to or more than the lower limit, excellent heat-seal strength is given. The upper limit of the average thickness is preferably 100 μm or less, more preferably 50 μm or less, even more preferably 40 μm or less, and particularly preferably 30 μm or less. If the average thickness is equal to or less than the upper limit, enhanced paper recyclability is achieved.

The lower limit of the ratio (M1/M2) of the weight of the paper layer, M1, to the total weight of the other layer(s), M2, is preferably 1.00 or more, more preferably 1.25 or more, even more preferably 2.33 or more, and particularly preferably 4.00 or more. If the ratio is equal to or more than the lower limit, enhanced paper recyclability is achieved. To calculate M2, for example, the weights of the layers are calculated from the thicknesses of the layers determined by measurement for a cross-section of a given multilayer structure and the specific weights of the layers, and summed up. The upper limit of the ratio (M1/M2) is preferably 300 or less, more preferably 100 or less, and even more preferably 50 or less. If the ratio is equal to or less than the upper limit, lower stress is applied at a bent part in forming a package, and the deterioration of the gas barrier properties is reduced.

### <Method for Producing Multilayer Structure Comprising Paper Layer and Layer Consisting of Modified EVOH (A)>

Examples of multilayering methods in producing the multilayer structure include solution coating methods (a direct gravure roll coating method, a gravure roll coating method, a kiss coating method, a reverse roll coating method, a fountain method, a transfer roll coating method), and extrusion coating methods, and a plurality of methods of them can be used. The modified EVOH (A) layer may be formed by directly applying the coating agent onto a paper substrate as the paper layer, or by forming an additional layer such as the above-described intermediate layer on a paper substrate and then applying the coating agent onto the additional layer. The thickness of the modified EVOH (A) layer (the thickness of the coating film) is as described above.

### <Applications of Multilayer Structure Comprising Paper Layer and Layer Consisting of Modified EVOH (A)>

Examples of applications of the multilayer structure include a package, and this is one of preferred modes. This package may be composed only of the multilayer structure, or of the multilayer structure and an additional member. The package can be produced with any of various methods. For example, a container (package) may be produced by forming a sheet-like multilayer structure or a film material including the multilayer structure (hereinafter, also referred to as a “film material”, simply) into a specific container shape by jointing. The package including the multilayer structure can be applied to various applications with utilization of its excellent gas barrier properties. The package is preferably used for applications that need gas barrier properties to oxygen and applications in which the inside of the package is purged with any of various functional gasses. For example, the package is preferably used as a package for foods. The package is preferably used not only as a package for foods, but also as a package or the like for packaging any of chemical products such as agrochemicals and drugs, medical tools and materials, industrial materials such as machine parts and precision materials, and clothing.

The multilayer structure may be for any of various packages formed by secondary processing. The package may be a vertical filling-and-sealing bag, a pouch, a vacuum package, a cup-like container, a bag, a lid material for containers, or an in-mold label.

### <Vertical Filling-and-Sealing Bag>

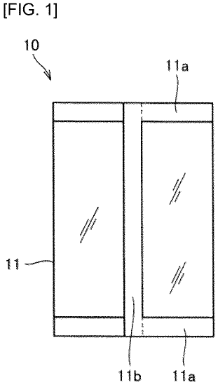

The package comprising the multilayer structure may be a vertical filling-and-sealing bag. An example thereof is shown in FIG. 1. The vertical filling-and-sealing bag 10 illustrated in FIG. 1 is formed in such a manner that a multilayer structure 11 is sealed along three sides of two edge parts 11a and a trunk part 11b. The vertical filling-and-sealing bag 10 can be manufactured with a vertical bag-making filling machine. While various methods are applied to bag making with a vertical bag-making filling machine, in any of the methods, a vertical filling-and-sealing bag is manufactured in such a manner that a content is fed from an upper opening of a bag into the inside and the opening is then sealed. For example, the vertical filling-and-sealing bag is composed of one film material heat-sealed on three sides of the upper edge, the lower edge, and the side edge. The vertical filling-and-sealing bag obtained with the multilayer structure maintains the excellent gas barrier performance even after bag making, and hence is capable of preventing the quality deterioration of the content for a long period of time.

### <Applications of Package>

The package comprising the multilayer structure has excellent gas barrier properties, and can exhibit much higher quality retention effect for contents in the case that the content of the package is a food. For enhanced storability for the food by suppressing the growth of microorganisms in the food, the water activity of the food in the package is preferably 0.94 or less, more preferably 0.80 or less, and even more preferably 0.60 or less. On the other hand, the water activity of the food is preferably 0.10 or more because excessively lowered water activity worsens the taste and texture of a food.

### EXAMPLES

The present invention will be specifically described below with reference to examples, but the present invention is by no means limited to those examples. The following shows evaluation methods employed for synthesis examples, examples, and comparative examples shown later.

### Ethylene Contents and Degrees of Saponification of Modified EVOH (A) and EVOH (B)

They were calculated from spectra obtained through ¹H-NMR (nuclear magnetic resonance) measurement (using “model JNM-GX-500” manufactured by JEOL Ltd.) with deuterated dimethyl sulfoxide as a solvent.

### Melting Points of Modified EVOH (A) and EVOH (B)

Measurement of the melting points of the modified EVOH (A) and the EVOH (B) were performed in accordance with JIS K 7121 with temperature increase from 30° C. to 200° C. at a rate of 10° C./min followed by rapid cooling to 0° C. at a rate of 50° C./min and rewarming from 0° C. to 200° C. at a temperature increase rate of 10° C./min (using the differential scanning calorimeter (DSC) “Q2000” manufactured by TA Instruments). Indium was used for calibration of temperature. The melting peak temperatures (Tₘ) were determined from charts of the 2nd runs in accordance with JIS K 7121, and used as the melting points of the modified EVOH (A) and the EVOH (B).

### Melt Flow Rates (MFRs) of Modified EVOH (A) and EVOH (B)

Measurement was performed with a Melt Indexer L244 (manufactured by Takara Kogyo Company Ltd.). Specifically, a cylinder having an inner diameter of 9.55 mm and a length of 162 mm was packed with powder, chips, or pellets of a resin to be subjected to the measurement (the modified EVOH (A) and the EVOH (B), or a resin composition), the resin was melted at 190° C., a load was evenly applied to the melted resin with a plunger having a weight of 2160 g and a diameter of 9.48 mm, and the flow-out rate (g/10 min) of the resin extruded from an orifice having a diameter of 2.1 mm and provided at the center of the cylinder was measured and used as the melt flow rate (MFR). For a resin having a melting point equal to or higher than 190° C., measurement was performed under two conditions: 210° C. and 230° C., and the reciprocal of absolute temperatures and the logarithm of MFRs were plotted on abscissa and ordinate, respectively, in a semilogarithmic graph, and a value obtained by extrapolation to 190° C. was used.

### Quantification of Alkali Metal Ions, Metal Salts, Phosphoric Acid Compounds, and Boron Compounds

In a pressure vessel made of Teflon®, 0.5 g of modified EVOH pellets obtained were put, to which 5 mL of concentrated nitric acid was added to decompose the pellets at room temperature for 30 minutes. After the decomposition, the pressure vessel was covered with a lid, and heated at 150° C. for 10 minutes and then at 180° C. for 5 minutes with a wet decomposer (“MWS-2” from ACTAC Co., Ltd.) for further decomposition, and then cooled to room temperature. The treated solution was transferred to a 50-mL volumetric flask, and diluted with ion-exchange water to give a sample solution for measurement. The metal element, phosphorus element, and boron element contents of the sample solution were measured with an ICP optical emission spectrometer (“OPTIMA 4300 DV” from ParkinElmer Inc.). Quantification analysis for the elements was carried out at observation wavelengths shown below. From a calibration curve prepared by using standard solutions and obtained values, the metal salt contents of the modified EVOH pellets in terms of alkali metal ion or metal element, the phosphoric acid compound content thereof in terms of phosphate radicals, and the boron compound content thereof in terms of boron element were determined.
Na: 589.592 nm
K: 766.490 nm
Mg: 285.213 nm
Ca: 317.933 nm
P: 214.914 nm
B: 249.667 nm

### Quantification of Carboxylate Ion

Dried modified EVOH (A) pellets were crushed by means of freeze crushing. The resulting crushed modified EVOH (A) was sieved through a sieve of 1 mm in nominal dimension (in accordance with JIS-Z8801, standards for test sieves). A 10-g portion of a modified EVOH (A) powder that had passed through the sieve and 50 mL of ion-exchange water were put in a 100-mL stoppered Erlenmeyer flask, a cooling condenser was attached, and the mixture was stirred at 95° C. for 10 hours for extraction. A 2-mL portion of the resulting extract solution was diluted with 8 mL of ion-exchange water. The diluted extract solution was subjected to quantification analysis with the ion chromatography “IC7000” manufactured by Yokogawa Electric Corporation to quantify the amount of carboxylate ions, and thereby the amounts of carboxylic acids and carboxylate ions were calculated. In the quantification, a calibration curve prepared by using aqueous solutions of acetic acid was used. Conditions for ion chromatography measurement:
Column: “ICE-AS-1” manufactured by Dionex IonPac
Eluent: 1.0 mmol/L octanesulfonic acid solution
Measurement temperature: 35° C.
Flow rate of eluent: 1 mL/min.
Sample injection volume: 50 μL

### Synthesis Example 1

### (1) Synthesis of Modified EVAc

A 250-L pressurized reaction tank equipped with a jacket, a stirrer, a nitrogen introduction port, an ethylene introduction port, and an initiator addition port was charged with 100 kg of vinyl acetate (R⁵ is a methyl group in the formula (V), hereinafter, referred to as VAc), 10 kg of methanol (hereinafter, occasionally referred to as MeOH), and 2.9 kg of 2-methylene-1,3-propanediol diacetate (R³ and R⁴ are each a hydrogen atom, and R⁶ and R⁷ are each a methyl group in the formula (VI), hereinafter, referred to as MPDAc), the temperature was increased to 60° C., and the reaction tank was then purged with nitrogen by nitrogen bubbling for 30 minutes. Then, ethylene was introduced to give a reaction tank pressure (ethylene pressure) of 4.9 MPa. The temperature in the reaction tank was adjusted to 60° C., and 60 g of 2,2′-azobis(2,4-dimethylvaleronitrile) (“V-65” manufactured by Wako Pure Chemical Industries, Ltd.) in a methanol solution was then added as an initiator to initiate polymerization. During the polymerization, the ethylene pressure and the polymerization temperature were maintained at 4.9 MPa and 60° C., respectively. When the polymerization ratio of VAc reached 45% 6 hours later, the polymerization was terminated by cooling. The reaction tank was opened to discharge ethylene, and bubbling was then performed with nitrogen gas to completely discharge ethylene. Subsequently, unreacted VAc was removed under reduced pressure, and MeOH was then added to the modified ethylene-vinyl acetate copolymer to which structural units derived from MPDAc had been introduced through copolymerization (hereinafter, occasionally referred to as the modified EVAc, formula (VIII)) to give a 20% by weight MeOH solution.

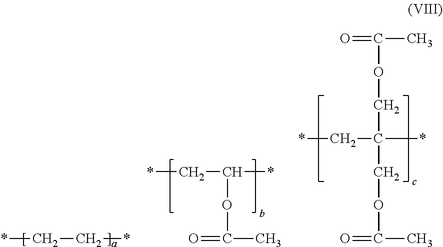

### (2) Saponification of Modified EVAc

A 500-L reaction tank equipped with a jacket, a stirrer, a nitrogen introduction port, a reflux condenser, and a solution addition port was charged with the 20% by weight MeOH solution of the modified EVAc obtained in (1). The temperature of the solution was increased to 60° C. while nitrogen was blown, and 0.5 equivalents of sodium hydroxide to the vinyl acetate units in the modified EVAc was added as a 2 N MeOH solution. After the completion of addition of the MeOH solution of sodium hydroxide, the resultant was stirred to allow the saponification reaction to proceed for 2 hours while the temperature in the system was kept at 60° C. and methyl acetate and MeOH were distilled off. Thereafter, acetic acid was added to terminate the saponification reaction. Then, ion-exchange water was added with stirring under heating at 60 to 80° C., and MeOH was distilled out of the reaction tank to precipitate the modified EVOH. The precipitated modified EVOH was collected, and crushed with a mixer. The resulting modified EVOH powder was put in 1 g/L aqueous solution of acetic acid (bath ratio: 20, a proportion of 20 L of aqueous solution to 1 kg of powder), and washed by stirring for 2 hours. The resultant was deliquored, further put in 1 g/L aqueous solution of acetic acid (bath ratio: 20), and washed by stirring for 2 hours. The resultant was deliquored, put in ion-exchange water (bath ratio: 20), and washed by stirring for 2 hours, and the resultant was deliquored: this operation was repeated three times in total for purification. Subsequently, the resultant was soaked and stirred in 10 L of an aqueous solution containing 0.5 g/L acetic acid and 0.1 g/L sodium acetate for 4 hours and then deliquored, and the resultant was dried at 60° C. for 16 hours to give a crude dried product of the modified EVOH.

### (3) Contents of Different Structural Units of Modified EVAc

The content ratio of ethylene units (a mol % in the formula (VIII)), the vinyl acetate unit content (b mol % in the formula (VIII)), and the content of structural units derived from MPDAc (c mol % in the formula (VIII)) in the modified EVAc were calculated from ¹H-NMR measurement for the modified EVAc before saponification.

First, a small amount of the MeOH solution of the modified EVAc obtained in (1) was sampled, and the modified EVAc was precipitated in ion-exchange water. The precipitate was collected, and dried at 60° C. under vacuum to give a dried product of the modified EVAc. Subsequently, the resulting dried product of the modified EVAc was dissolved in dimethyl sulfoxide (DMSO)-d₆ containing tetramethylsilane as an internal standard substance, and subjected to 500 MHz ¹H-NMR measurement (“GX-500” manufactured by JEOL Ltd.) at 80° C.

Peaks in the ¹H-NMR spectrum of the modified EVAc are assigned as follows.
0.6 to 1.0 ppm: methylene protons of ethylene units at terminal sites (4H)
1.0 to 1.85 ppm: methylene protons of ethylene units at intermediate sites (4H), methylene protons of main chain sites of structural units derived from MPDAc (2H), and methylene protons of vinyl acetate units (2H)
1.85 to 2.1 ppm: methyl protons of structural units derived from MPDAc (6H) and methyl protons of vinyl acetate units (3H)
3.7 to 4.1 ppm: methylene protons of side chain sites of structural units derived from MPDAc (4H)
4.4 to 5.3 ppm: methine protons of vinyl acetate units (1H)

As the integral from 0.6 to 1.0 ppm was defined as x, the integral from 1.0 to 1.85 ppm as y, the integral from 3.7 to 4.1 ppm as z, and the integral from 4.4 to 5.3 ppm as w according to those assignments, the content ratio of ethylene units, a (mol %), the vinyl acetate unit content, b (mol %), and the content ratio of structural units derived from MPDAc, c (mol %), are calculated from the following expressions.

$$a = ( 2 x + 2 y - z - 4 w ) / ( 2 x + 2 y + z + 4 w ) \times 100$$

$$b = 8 w / ( 2 x + 2 y + z + 4 w ) \times 100$$

$$c = 2 z / ( 2 x + 2 y + z + 4 w ) \times 100$$

The results of calculation according to the method showed that the content ratio of ethylene units, a, of the modified EVAc in Synthesis Example 1 was 38.0 mol %, the content ratio of vinyl acetate units, b, was 60.5 mol %, and the content ratio of structural units derived from MPDAc, c, was 1.5 mol %. The values of a, b, and c in the modified EVAc are the same as the values of a, b, and c in the modified EVOH (A) after the saponification treatment.

### (4) Degree of Saponification of Modified EVOH (A)

Similarly, ¹H-NMR measurement was performed for the modified EVOH after saponification. The crude dried product of the modified EVOH obtained in (2) was dissolved in dimethyl sulfoxide (DMSO)-d₆ containing tetramethylsilane as an internal standard substance and tetrafluoroacetic acid (TFA) as an additive, and subjected to 500 MHz ¹H-NMR measurement (“GX-500” manufactured by JEOL Ltd.) at 80° C. The result of the ¹H-NMR measurement showed significant decrease in the peak intensity in 1.85 to 2.1 ppm, and hence it was obvious that not only ester groups derived from vinyl acetate in the modified EVOH but also ester groups contained in structural units derived from MPDAc had been saponified into hydroxy groups. The degree of saponification was calculated from the peak intensity ratio between methyl protons of vinyl acetate units (1.85 to 2.1 ppm) and methine protons of vinyl alcohol units (3.15 to 4.15 ppm). The degree of saponification of the modified EVOH (A1) in Synthesis Example 1 was 99.9 mol % or more. The analysis results for the modified EVOH (A1) are shown in Table 1.

### Synthesis Example 2

A modified EVOH (A2) was synthesized and analyzed in the same manner as in Synthesis Example 1 except that, in soaking and stirring in 10 L of an aqueous solution containing 0.5 g/L acetic acid and 0.1 g/L sodium acetate for 4 hours after the modified EVAc obtained in Synthesis Example 1 was saponified, an aqueous solution containing 0.02 g/L boric acid in addition to acetic acid and sodium acetate was used. The results are shown in Table 1.

### Synthesis Examples 3 to 8

Modified EVOHs (A3 to A7) and an unmodified EVOH (B4) were synthesized and analyzed in the same manner as in Synthesis Example 1 except that the polymerization conditions were changed as shown in Table 1. The results are shown in Table 1.

### Synthesis Example 9

EVOH (B1) (ethylene content: 38 mol %, EVAL H171B, manufactured by Kuraray Co., Ltd.) was subjected to freeze crushing to give powder of 0.5 mm in diameter, and the powder was put in 1 g/L aqueous solution of acetic acid (bath ratio: 20, a proportion of 20 L of aqueous solution to 1 kg of powder), and washed by stirring for 2 hours. The resultant was deliquored, further put in 1 g/L aqueous solution of acetic acid (bath ratio: 20), and washed by stirring for 2 hours. The resultant was deliquored, put in ion-exchange water (bath ratio: 20), and washed by stirring for 2 hours, and the resultant was deliquored: this operation was repeated three times in total for purification. Subsequently, the resultant was soaked and stirred in 10 L of an aqueous solution containing 0.5 g/L acetic acid and 0.1 g/L sodium acetate for 4 hours and then deliquored, and the resultant was dried at 60° C. for 16 hours, and then at 110° C. for 6 hours to give a dried product of EVOH.

Mixed were 28 parts by weight of zinc acetylacetonate monohydrate and 957 parts by weight of 1,2-dimethoxyethane, giving a mixed solution. To the resulting mixed solution, 15 parts by weight of trifluoromethanesulfonic acid was added with stirring, giving a solution containing a catalyst. Specifically, a catalyst solution containing 1 mol of trifluoromethanesulfonic acid mixed with 1 mol of zinc acetylacetonate monohydride was prepared.

The dried product of EVOH was added to a TEM-35BS extruder (37 mmφ, L/D=52.5, extruder preset temperature: 200° C., screw rotational frequency: 250 rpm) manufactured by Toshiba Machine Co., Ltd. at 11 kg/hr. The inner pressure was decreased to 60 mmHg via a vent site on the entrance side of the extruder, epoxypropane and the catalyst solution were mixed so that the former and the latter were added at rates of 0.4 kg/hr and 0.20 kg/hr, respectively, and the mixture was fed from the center of the extruder. Subsequently, unreacted epoxypropane was removed from a vent present on the exit side of the extruder at normal pressure, and 8.2% by weight aqueous solution of trisodium ethylenediaminetetraacetate trihydrate as a catalyst deactivator was then added at a rate of 0.11 kg/hr from a site immediately before the exit of the extruder. The resin coming out of the exit of the extruder was successively cut, giving a modified EVOH (A8). The MFR and the melting point of the resulting modified EVOH (A8) were 1 g/10 min (190° C., under a load of 2160 g) and 161° C., respectively.

The chemical structure of the thus-obtained modified EVOH (A8), which had been modified with epoxypropane, was determined by NMR measurement for the modified EVOH (A8) after trifluoroacetylation thereof in the following procedure.

The modified EVOH (A8) produced as above was crushed into powder of 0.2 mm or less in particle size, and a 1-g portion of the powder was then put in a 100-mL eggplant flask, to which 20 g of methylene chloride and 10 g of trifluoroacetic anhydride were added, and the resultant was stirred at room temperature. One hour after the initiation of stirring, the modified EVOH completely dissolved. After the complete dissolution of the modified EVOH, stirring was further performed for 1 hour, and the solvent was then removed with a rotary evaporator. The resulting trifluoroacetylated modified EVOH was dissolved in a mixed solvent of deuterated chloroform and trifluoroacetic anhydride (deuterated chloroform/trifluoroacetic anhydride=2/1 (weight ratio)) at a concentration of 2 g/L, and the 500 MHz ¹H-NMR was measured with use of tetramethylsilane as an internal standard.

For the chemical structure of the modified EVOH (A8), which had been modified with epoxypropane, the contents of different structural units were determined according to a method described in Patent Literature 4 to find that the ethylene content was 38 mol % and the epoxypropane content was 1.5 mol %. The analysis results for the obtained resin are shown in Table 1.

TABLE 1

| | | Polymerization conditions | | | | | | | | |
|---|---|---|---|---|---|---|---|---|---|---|
| | | | | | | | | Polymer- | | Final |
| | | Initial amount of charge | | | | | | ization | Polymer- | polymer- |
| | | Vinyl | | Modifying | | Ethylene | | temper- | ization | ization |
| | | acetate | Methanol | agent | | pressure | Initiator | ature | time | ratio |
| | Name | kg | kg | Type¹⁾ | kg | MPa | g | ° C. | hour | % |
| Synthesis | A1 | 100 | 10 | MPDAc | 2.9 | 4.9 | 60 | 60 | 6 | 45 |
| Example 1 | | | | | | | | | | |
| Synthesis | A2 | 100 | 10 | MPDAc | 2.9 | 4.9 | 60 | 60 | 6 | 45 |
| Example 2 | | | | | | | | | | |
| Synthesis | A3 | 120 | 12 | MPDAc | 1.8 | 3.5 | 44 | 60 | 6.5 | 49 |
| Example 3 | | | | | | | | | | |
| Synthesis | A4 | 120 | 15 | MPDAc | 0.6 | 3.2 | 30 | 60 | 5 | 45 |
| Example 4 | | | | | | | | | | |
| Synthesis | A5 | 120 | 6 | MPDAc | 10 | 3.8 | 84 | 60 | 10 | 9 |
| Example 5 | | | | | | | | | | |
| Synthesis | A6 | 120 | 14 | MPDAc | 1.8 | 2.9 | 35 | 60 | 7 | 47 |
| Example 6 | | | | | | | | | | |
| Synthesis | A7 | 100 | 20 | MPDAc | 1.8 | 6.7 | 60 | 60 | 4 | 30 |
| Example 7 | | | | | | | | | | |
| Synthesis | B4 | 100 | 20 | none | — | 6.8 | 30 | 60 | 8 | 40 |
| Example 8 | | | | | | | | | | |
| Synthesis | A8 | — | | | | | | | | |
| Example 9 | | | | | | | | | | |

| | Modified EVOH (A) or EVOH (B) | | | | | | |
|---|---|---|---|---|---|---|---|
| | | | Degree of | | | | |
| | Content | Content | saponifi- | Melting | MFR | Sodium | Boric |
| | ratio a | ratio c²⁾ | cation (DS) | point | g/10 | ion | acid |
| | mol % | mol % | mol % | ° C. | min | ppm | ppm |
| Synthesis | 38 | 1.5 | ≥99.9 | 161 | 6 | 200 | 0 |
| Example 1 | | | | | | | |
| Synthesis | 38 | 1.5 | ≥99.9 | 161 | 2 | 200 | 600 |
| Example 2 | | | | | | | |
| Synthesis | 27 | 1.0 | ≥99.9 | 183 | 3 | 200 | 0 |
| Example 3 | | | | | | | |
| Synthesis | 27 | 0.3 | ≥99.9 | 187 | 2 | 200 | 0 |
| Example 4 | | | | | | | |
| Synthesis | 27 | 8.0 | ≥99.9 | 125 | 4 | 200 | 0 |
| Example 5 | | | | | | | |
| Synthesis | 24 | 1.0 | ≥99.9 | 190 | 3 | 200 | 0 |
| Example 6 | | | | | | | |
| Synthesis | 55 | 1.0 | ≥99.9 | 138 | 9 | 200 | 0 |
| Example 7 | | | | | | | |
| Synthesis | 55 | — | ≥99.9 | 145 | 8 | 200 | 0 |
| Example 8 | | | | | | | |
| Synthesis | 38 | 1.5²⁾ | ≥99.9 | 161 | 1 | 200 | 0 |
| Example 9 | | | | | | | |

¹⁾MPDAc: 2-methylene-1,3-propanediol diacetate
²⁾Indicating content ratio of epoxypropane (mol %) for Synthesis Example 9

### Example 1

### Modified EVOH (A) Solution

The modified EVOH (A1) obtained in Synthesis Example 1 was completely dissolved in an n-propyl alcohol/water mixed solvent (weight ratio: 70/30) to prepare a solution containing 15% by weight of the modified EVOH (A1). For coating test shown below (production and evaluation of coat films), the solution stored under an environment at 20° C. and 65% RH for 1 day after preparation was used.

### Solution Viscosity

The solution viscosity of the prepared solution was measured with the analog viscometer LVT (manufactured by Brookfield Engineering) under a condition of 23° C. The viscosity immediately after preparation of the solution was defined as V₀, and the viscosity after storing the solution in an environment at 20° C. for 7 days (1 week) as V₇. The solution was homogenized by stirring before each measurement, and viscosity measurement was then performed with the temperature stabilized at 23° C. for 30 minutes. As the viscosity change after storing the solution |(V₇−V₀)/V₀| was smaller, the viscosity stability of the solution was determined to be higher.

### Measurement of Transmittance of Solution

The light transmittance of the prepared solution at a wavelength of 800 nm was measured with an ultraviolet and visible spectrophotometer (UV-2450 manufactured by Shimadzu Corporation). In the measurement, the solution that had been stirred, left to stand, and defoamed in advance was added to a quartz cell having an optical path length of 1 cm, and measurement was performed as the transmittance for a quartz cell to which only the solvent was added was assumed as 100%. To evaluate the storage stability of the solution, the light transmittance was measured at 20° C. immediately after preparation of the solution (T₀), after storing under a condition of 15° C. for 1 day, and after storing under a condition of 20° C. for 7 days (1 week) (T₇). As higher light transmittance was successfully maintained even after storing for a long period of time or at low temperature, the stability of the solution was determined to be higher.

### Production of Coat Film (Multilayer Structure)

A polyester anchor coat agent (Toyo-Morton Ltd., brand: AD-335A) was applied onto a polyethylene terephthalate film having a thickness of 25 m with a bar coater at 1 g/m² in terms of the solid content. Subsequently, the modified EVOH solution was applied with a bar coater, and dried with a hot-air dryer at 60° C. for 3 minutes. The obtained multilayer structure was cut with a microtome to form a cross-section, which was observed with an optical microscope and the thickness of the modified EVOH (A) layer was measured; as a result, the average thickness was found to be 5 μm. The obtained coat film had neither whitening nor fogging, being very transparent and beautiful.

### Measurement of Haze of Coat Film

The coat film was subjected to humidity control under an environment at 20° C. and 65% RH for 5 days. Haze measurement was performed for the coat film after the humidity control with a haze/transmittance/reflectance meter (HR-100 manufactured by MURAKAMI COLOR RESEARCH LABORATORY CO., LTD.).

### Oxygen Transmission Rate (OTR) of Coat Film

The coat film was subjected to humidity control under an environment at 20° C. and 65% RH for 5 days. The oxygen transmission rate of the coat film after the humidity control was measured with model MOCON OX-TRAN2/21 manufactured by MOCON Inc. under conditions of 20° C. and 65% RH in accordance with a method described in JIS K7126 (Equal-pressure method). In the measurement, two samples were subjected to measurement, the average value was converted into a value for the coat layer with a thickness of 20 μm (cc·20 μm/m²·day·atm), and the value was determined as the oxygen transmission rate. Since the oxygen transmission rate of the polyethylene terephthalate film as a substrate is far higher than that of the layer formed by applying the modified EVOH (A) or EVOH (B), the influence of the substrate on the oxygen transmission rate of the coat film can be neglected.

The modified EVOH (A) solution did not undergo reduction in the transmission rate even after storage for 7 days. The oxygen transmission rate of the coat film produced with the modified EVOH (A) solution after storage under an environment at 20° C. and 65% RH for 1 day was 0.75 cc·20 μm/m²·day·atm, and the oxygen transmission rate of the coat film produced with the solution after storage at 20° C. for 7 days was also 0.75 cc·20 μm/m²·day·atm; thus, the coat film exhibited good gas barrier properties. The evaluation results are summarized in Tables 2 and 3.

### Example 2

To a solution containing 15% by weight of the modified EVOH (A1) obtained in Example 1, amorphous silica (brand: SYLYSIA 350, manufactured by FUJI SILYSIA CHEMICAL LTD., average particle size: 3.9 μm) was added to give an amorphous silica content of 1000 ppm to the amount of the modified EVOH (A1), and the resultant was then stirred and mixed to prepare a solution. Production, evaluation, and analysis of a coat film were performed in the same manner as in Example 1 except that the solution was used. The results are shown in Tables 2 and 3.

### Examples 3 to 9

Preparation of a modified EVOH solution, production of a coat film, and evaluation and analysis of them were performed in the same manner as in Example 1 except that a modified EVOH and a solvent shown in Table 2 were used for preparation of a modified EVOH solution. The results are shown in Tables 2 and 3.

### Example 10

Preparation of a modified EVOH solution, production of a coat film, and evaluation and analysis of them were performed in the same manner as in Example 1 except that the modified EVOH (A7) obtained in Synthesis Example 7 was used as a modified EVOH and N-methylpyrrolidone was used as a solvent for use in preparing a modified EVOH solution, and that the drying temperature after applying the modified EVOH solution was changed to 140° C. The results are shown in Tables 2 and 3.

### Example 11

The unmodified EVOH (B4) obtained in Synthesis Example 8, which had an ethylene content of 55 mol % and a degree of saponification of >99.9 mol %, was dissolved in n-propyl alcohol/water (mixed weight ratio: 80/20) to prepare a solution containing 15% by weight of EVOH-B4. This solution and the solution of modified EVOH-A1 obtained in Example 1 were mixed at a weight ratio of 1:2 and stirred to prepare a coating solution. The weight ratio between the modified EVOH (A) and the unmodified EVOH (B) in the solution was modified EVOH (A):unmodified EVOH (B)=2:1. Production, evaluation, and analysis of a coat film were performed in the same manner as in Example 1 except that the solution was used. The results are shown in Tables 2 and 3.

### Comparative Examples 1 to 5

Preparation of an EVOH solution and production of a coat film were performed in the same manner as in Example 1 except that EVOH (B1) (Comparative Example 1, ethylene content: 38 mol %, EVAL H171B, manufactured by Kuraray Co., Ltd.), EVOH (B2) (Comparative Example 2, ethylene content: 27 mol %, EVAL L171B, manufactured by Kuraray Co., Ltd.), EVOH (B3) (Comparative Example 3, ethylene content: 24 mol %, EVAL M100B, manufactured by Kuraray Co., Ltd.), the unmodified EVOH (B4) obtained in Synthesis Example 8 (Comparative Example 4), or the modified EVOH (A8) obtained in Synthesis Example 9, which had been modified with epoxypropane (Comparative Example 5), was used in place of the modified EVOH (A), and a solvent shown in Table 2 was used. The storage stability of each of the EVOH solutions obtained in Comparative Examples 1 to 5, and the haze and oxygen transmission rate of the coat film were evaluated in the same manner as in Example 1. The coat films obtained in Comparative Examples 1 to 3 were found to have fogging, thus being poor in appearance. The evaluation results are shown in Tables 2 and 3.

### Comparative Example 6

Preparation of an EVOH solution, production of a coat film, and evaluation and analysis of them were performed in the same manner as in Example 1 except that the unmodified EVOH (B4) obtained in Synthesis Example 8 was used as EVOH and N-methylpyrrolidone was used as a solvent for use in preparation of an EVOH solution, and that the drying temperature after applying the EVOH solution was changed to 140° C. The results are shown in Tables 2 and 3.

TABLE 2

| | Modified EVOH (A), EVOH (B) | | | | | | | | | | |
|---|---|---|---|---|---|---|---|---|---|---|---|
| | | | | | | | MFR | | | | |
| | | | | | DS | | 190° C., | Solution | | | |
| | | | | | Expres- | | load of | Modified | | | |
| | | | | | sion | Melting | 2160 g | EVOH | EVOH | Solvent | |
| | Synthesis | | a | c | (4) | point | g/10 | (A) | (B) | Water | NPA⁴⁾ |
| | Example | Name | mol % | mol % | mol % | ° C. | min | wt % | wt % | wt % | wt % |
| Example 1 | 1 | A1 | 38 | 1.5¹⁾ | ≥99.9 | 161 | 6 | 15 | 0 | 25.5 | 59.5 |
| Example 2³⁾ | 1 | A1 | 38 | 1.5¹⁾ | ≥99.9 | 161 | 6 | 15 | 0 | 25.5 | 59.5 |
| Example 3 | 2 | A2 | 38 | 1.5¹⁾ | ≥99.9 | 161 | 2 | 15 | 0 | 25.5 | 59.5 |
| Example 4 | 3 | A3 | 27 | 1.0¹⁾ | ≥99.9 | 183 | 3 | 15 | 0 | 42.5 | 42.5 |
| Example 5 | 4 | A4 | 27 | 0.3¹⁾ | ≥99.9 | 187 | 2 | 15 | 0 | 42.5 | 42.5 |
| Example 6 | 5 | A5 | 27 | 8.0¹⁾ | ≥99.9 | 125 | 4 | 15 | 0 | 42.5 | 42.5 |
| Example 7 | 6 | A6 | 24 | 1.0¹⁾ | ≥99.9 | 190 | 3 | 15 | 0 | 59.5 | 25.5 |
| Example 8 | 7 | A7 | 55 | 1.0¹⁾ | ≥99.9 | 138 | 9 | 15 | 0 | 17 | 68 |
| Example 9 | 7 | A7 | 55 | 1.0¹⁾ | ≥99.9 | 138 | 9 | 15 | 0 | 17 | 0 |
| Example 10 | 7 | A7 | 55 | 1.0¹⁾ | ≥99.9 | 138 | 9 | 15 | 0 | 0 | 0 |
| Example 11 | 7 | A7 | 55 | 1.0¹⁾ | ≥99.9 | 138 | 9 | 10 | 5 | 17 | 68 |
| | 8 | B4 | 55 | — | ≥99.9 | 145 | 8 | | | | |
| Comparative | — | B1⁷⁾ | 38 | — | ≥99.9 | 172 | 2 | 0 | 15 | 25.5 | 59.5 |
| Example 1 | | | | | | | | | | | |
| Comparative | — | B2⁸⁾ | 27 | — | ≥99.9 | 190 | 1 | 0 | 15 | 42.5 | 42.5 |
| Example 2 | | | | | | | | | | | |
| Comparative | — | B3⁹⁾ | 24 | — | ≥99.9 | 196 | 0.8 | 0 | 15 | 59.5 | 25.5 |
| Example 3 | | | | | | | | | | | |
| Comparative | 8 | B4 | 55 | — | ≥99.9 | 145 | 8 | 0 | 15 | 17 | 68 |
| Example 4 | | | | | | | | | | | |
| Comparative | 9 | A8 | 38 | 1.5²⁾ | ≥99.9 | 161 | 1 | 15 | 0 | 25.5 | 59.5 |
| Example 5 | | | | | | | | | | | |
| Comparative | 8 | B4 | 55 | — | ≥99.9 | 145 | 8 | 0 | 15 | 0 | 0 |
| Example 6 | | | | | | | | | | | |

| | | | Evaluation | | | | | | |
|---|---|---|---|---|---|---|---|---|---|
| | | | | | | | Solution | | |
| | | | Light | Light | | Light | viscosity | Solution | |
| | | | transmittance | transmittance | | transmittance | immediately | viscosity | |
| | Solution | | immediately | after storage | | after storage | after | after | |
| | Solvent | | after | at 20° C. for | | at 15° C. | preparation | storage for | \|(V₇ − |
| | IPA⁵⁾ | NMP⁶⁾ | preparation T₀ | 7 days T₇ | T₀ − T₇ | for 1 day | V₀ | 7 days V₇ | V₀)/V₀\| |
| | wt % | wt % | % | % | % | % | cP | cP | % |
| Example 1 | 0 | 0 | 99% | 99% | 0% | 95% | 640 | 640 | 0% |
| Example 2³⁾ | 0 | 0 | 67% | 67% | 0% | 65% | 650 | 650 | 0% |
| Example 3 | 0 | 0 | 99% | 99% | 0% | 96% | 660 | 660 | 0% |
| Example 4 | 0 | 0 | 99% | 97% | 2% | 93% | 720 | 730 | 1% |
| Example 5 | 0 | 0 | 99% | 75% | 24% | 64% | 690 | 710 | 3% |
| Example 6 | 0 | 0 | 99% | 99% | 0% | 99% | 790 | 790 | 0% |
| Example 7 | 0 | 0 | 99% | 97% | 2% | 91% | 650 | 660 | 2% |
| Example 8 | 0 | 0 | 99% | 98% | 1% | 97% | 610 | 620 | 2% |
| Example 9 | 68 | 0 | 99% | 97% | 2% | 94% | 620 | 640 | 3% |
| Example 10 | 0 | 85 | 99% | 99% | 0% | 99% | 600 | 600 | 0% |
| Example 11 | 0 | 0 | 99% | 78% | 21% | 75% | 610 | 640 | 5% |
| Comparative | 0 | 0 | 99% | 7% | 92% | 3% | 570 | 680 | 19% |
| Example 1 | | | | | | | | | |
| Comparative | 0 | 0 | 99% | 6% | 93% | 2% | 690 | 840 | 22% |
| Example 2 | | | | | | | | | |
| Comparative | 0 | 0 | 99% | 5% | 94% | 1% | 750 | 960 | 28% |
| Example 3 | | | | | | | | | |
| Comparative | 0 | 0 | 99% | 9% | 90% | 5% | 610 | 720 | 18% |
| Example 4 | | | | | | | | | |
| Comparative | 0 | 0 | 99% | 95% | 4% | 90% | 700 | 750 | 7% |
| Example 5 | | | | | | | | | |
| Comparative | 0 | 85 | 99% | 45% | 54% | 40% | 590 | 660 | 12% |
| Example 6 | | | | | | | | | |

¹⁾Content ratio of MPDAc (2-methylene-1,3-propanediol diacetate),
²⁾Content ratio of epoxypropane,
³⁾Content ratio of amorphous silica (manufactured by FUJI SILYSIA CHEMICAL LTD.“SYLYSIA 350”, average particle size: 3.9 μm) to content of EVOH resin composition: 1000 ppm,
⁴⁾NPA: normal-propanol,
⁵⁾IPA: isopropanol,
⁶⁾NMP: N-methylpyrrolidone,
⁷⁾EVAL H171B,
⁸⁾EVAL L171B,
⁹⁾EVAL M100B

TABLE 3

| | | | Film (solution after | | OTR |
|---|---|---|---|---|---|
| | Film (solution after | | storing at 20° C. | | deterio- |
| | storing for 1 day) | | for 7 days) | | ration |
| | OTR₁¹⁾ | | OTR₇¹⁾ | | rate ²⁾ |
| | (20° C., | | (20° C., | | of coat |
| | 65% RH) | | 65% RH) | | film after |
| | cc · 20 μm/m² · | | cc · 20 μm/m² · | | storage of |
| | day · atm | Haze | day · atm | Haze | solution |
| Example 1 | 0.75 | <1 | 0.75 | <1 | 0% |
| Example 2 | 0.65 | 1 | 0.65 | 1 | 0% |
| Example 3 | 0.75 | <1 | 0.75 | <1 | 0% |
| Example 4 | 0.08 | <1 | 0.09 | <1 | 13% |
| Example 5 | 0.09 | <1 | 0.11 | 3 | 22% |
| Example 6 | 0.06 | <1 | 0.06 | <1 | 0% |
| Example 7 | 0.07 | <1 | 0.08 | <1 | 14% |
| Example 8 | 4.9 | <1 | 5.2 | <1 | 6% |
| Example 9 | 4.9 | <1 | 5.4 | <1 | 10% |
| Example 10 | 4.7 | <1 | 4.7 | <1 | 0% |
| Example 11 | 5.2 | <1 | 6.3 | 3 | 21% |
| Comparative | 1.20 | >10 | 1.50 | >50 | 25% |
| Example 1 | | | | | |
| Comparative | 0.15 | >10 | 0.20 | >50 | 33% |
| Example 2 | | | | | |
| Comparative | 0.12 | >10 | 0.18 | >50 | 50% |
| Example 3 | | | | | |
| Comparative | 7.2 | 5 | 9.5 | >10 | 32% |
| Example 4 | | | | | |
| Comparative | 1.10 | <1 | 1.40 | 5 | 27% |
| Example 5 | | | | | |
| Comparative | 5.7 | <1 | 7.2 | >10 | 26% |
| Example 6 | | | | | |

¹⁾OTR: oxygen transmission rate,
²⁾ OTR deterioration rate (%) = 100 × (OTR₁ − OTR₇)/OTR₁

As shown in Tables 2 and 3, the solution of Example 1, containing the modified EVOH (A), was excellent in storage stability at normal temperature and low temperature and allowed formation of a coating film having good appearance with low haze, and the gas barrier properties were also good. In contrast to this, the solution of Comparative Example 1, containing only the unmodified EVOH (B), was poor in all of the storage stability, and the appearance and gas barrier properties of the coating film to be formed.

### Synthesis Example 10

Purification of modified EVOH powder obtained by crushing and the preceding operations were performed in the same manner as in Synthesis Example 1 except that, in saponifying the modified EVAc, a series of operations of putting the modified EVOH in ion-exchange water (bath ratio: 20), washing by stirring for 2 hours, and deliquoring was repeated six times. The conductivity of the washing solution after the sixth washing was measured with a “CM-30ET” manufactured by TOA Electronics Ltd. to be 3 μS/cm. The water content of the obtained water-containing modified EVOH pellets was 110% by mass (the water content of water-containing EVOH is % by mass on dry EVOH basis, and determined as (Mw−Ms)/Ms×100, wherein Mw denotes the mass of water-containing pellets, and Ms denotes the mass of EVOH after being dried).

In 94.5 L of an aqueous solution obtained by dissolving components in water to give 0.8 g/L acetic acid, 0.64 g/L sodium acetate, and 0.016 g/L phosphoric acid, 10.5 kg of the water-containing EVOH pellets obtained above was put, and subjected to soaking at 25° C. for 6 hours with stirring at intervals. The water-containing EVOH pellets after the soaking was dehydrated through centrifugal deliquoring, and the resultant was then dried in a hot-air dryer at 80° C. for 3 hours, and subsequently at 120° C. for 24 hours, giving a modified EVOH (A9) as dry EVOH resin composition pellets. The amount of sodium as an alkali metal in the modified EVOH (A9) was 200 ppm (8.7 μmol/g). The analysis results for the modified EVOH (A9) are shown in Table 5.

### Synthesis Examples 11 to 19

Production and analysis of a modified EVAc and dry EVOH resin composition pellets were performed in the same manner as in Synthesis Example 10 except that the polymerization conditions for the modified EVOH and the composition of the solution for soaking the water-containing modified EVOH pellets were changed as shown in Table 4. The results are shown in Table 4.

TABLE 4

| | | Polymerization conditions | | | | | | | | | | |
|---|---|---|---|---|---|---|---|---|---|---|---|---|
| | | | | | | | | Polymer- | | Final | Modified | |
| | | Initial amount of charge | | | | | | ization | Polymer- | polymer- | EVOH (A) | |
| | | Vinyl | Meth- | Modifying | | Ethylene | Initi- | temper- | ization | ization | Content | Content |
| | | acetate | anol | agent | | pressure | ator | ature | time | ratio | ratio of a | ratio of c |
| | Name | kg | kg | Type | kg | MPa | g | ° C. | hour | % | mol % | mol % |
| Synthesis | A9 | 100 | 10 | MPDAc¹⁾ | 2.9 | 4.9 | 60 | 60 | 6 | 45 | 38 | 1.5 |
| Example 10 | | | | | | | | | | | | |
| Synthesis | A10 | | | | | | | | | | | |
| Example 11 | | | | | | | | | | | | |
| Synthesis | A11 | | | | | | | | | | | |
| Example 12 | | | | | | | | | | | | |
| Synthesis | A12 | | | | | | | | | | | |
| Example 13 | | | | | | | | | | | | |
| Synthesis | A13 | | | | | | | | | | | |
| Example 14 | | | | | | | | | | | | |
| Synthesis | A14 | 120 | 12 | | 1.8 | 3.5 | 44 | 60 | 7 | 49 | 27 | 1.0 |
| Example 15 | | | | | | | | | | | | |
| Synthesis | A15 | 120 | 15 | | 0.6 | 3.2 | 30 | 60 | 5 | 45 | 27 | 0.3 |
| Example 16 | | | | | | | | | | | | |
| Synthesis | A16 | 120 | 6 | | 10 | 3.8 | 84 | 60 | 10 | 9 | 27 | 8.0 |
| Example 17 | | | | | | | | | | | | |
| Synthesis | A17 | 100 | 20 | | 1.8 | 6.7 | 60 | 60 | 4 | 30 | 55 | 1.0 |
| Example 18 | | | | | | | | | | | | |
| Synthesis | B5 | 100 | 10 | — | — | 5.1 | 15 | 60 | 4 | 45 | 38 | — |
| Example 19 | | | | | | | | | | | | |

| | Modified | | | | | | | | |
|---|---|---|---|---|---|---|---|---|---|
| | EVOH | Concentrations of components blended | | | | Contents to modified | | | |
| | (A) | in aqueous solution (g/L) | | | | EVOH (A) | | | |
| | Degree of | Acetic | | | Phosphoric | Acetic | | | Phosphoric |
| | saponifi- | acid | Metal ion | | acid | acid | Metal ion | | acid |
| | cation | Concen- | | Concen- | Concen- | Concen- | | Concen- | Concen- |
| | (DS) | tration | | tration | tration | tration | | tration | tration |
| | mol % | g/L | Type | g/L | g/L | ppm | Type | μmol/g | ppm |
| Synthesis | ≥99.9 | 0.80 | sodium | 0.64 | 0.016 | 200 | Na | 8.7 | 10 |
| Example 10 | | | acetate | | | | | | |
| Synthesis | | 0.80 | | 1.45 | 0.016 | 200 | Na | 19.6 | 10 |
| Example 11 | | | | | | | | | |
| Synthesis | | 0.80 | | 0.19 | 0.016 | 200 | Na | 2.6 | 10 |
| Example 12 | | | | | | | | | |
| Synthesis | | 0.80 | | 0.03 | 0.016 | 200 | Na | 0.4 | 10 |
| Example 13 | | | | | | | | | |
| Synthesis | | 0.80 | potassium | 0.77 | 0.016 | 200 | K | 8.7 | 10 |
| Example 14 | | | acetate | | | | | | |
| Synthesis | | 0.80 | sodium | 0.64 | 0.016 | 200 | Na | 8.7 | 10 |
| Example 15 | | | acetate | | | | | | |
| Synthesis | | 0.80 | | 0.64 | 0.016 | 200 | Na | 8.7 | 10 |
| Example 16 | | | | | | | | | |
| Synthesis | | 0.80 | | 0.64 | 0.016 | 200 | Na | 8.7 | 10 |
| Example 17 | | | | | | | | | |
| Synthesis | | 0.80 | | 0.64 | 0.016 | 200 | Na | 8.7 | 10 |
| Example 18 | | | | | | | | | |
| Synthesis | | 0.80 | | 0.64 | 0.016 | 200 | Na | 8.7 | 10 |
| Example 19 | | | | | | | | | |

¹⁾Modifying agent 1: 2-methylene-1,3-propanediol diacetate

The thus-obtained dry EVOH resin composition pellets and the following materials were used for production of a multilayer structure comprising a paper layer and a modified EVOH (A) layer.

### <Paper Layer>

Bleached kraft paper: Snow Queen G40, basis weight of 50 g/m², manufactured by Daio Paper Corporation
Glassine paper: thick glassine, basis weight of 31 g/m², manufactured by Nippon Paper Industries Co., Ltd.
Bleached kraft paper: basis weight of 140 g/m², manufactured by Nippon Paper Industries Co., Ltd.
Kraft cardboard: S Kraft Cardboard, basis weight of 290 g/m², manufactured by Nippon Paper Industries Co., Ltd.
Kraft cardboard: S Kraft Cardboard, basis weight of 450 g/m², manufactured by Nippon Paper Industries Co., Ltd.

### <Intermediate Layer>

Anchor coat agent: “ZAIKTHENE AC” (polyolefin copolymer manufactured by Sumitomo Seika Chemicals Company, Limited.)
Adhesive resin “Bondine TX8030” (manufactured by Arkema S.A.)

### <Sealant Layer>

“ZAIKTHENE AC” (polyolefin copolymer manufactured by Sumitomo Seika Chemicals Company, Limited.)
Unstretched polypropylene film (CPP, thickness: 30 μm) “TORAYFAN RNO 3951” (manufactured by TORAY ADVANCED FILM Co., Ltd.)

### Example 12

Bleached kraft paper (basis weight: 50 g/m²) was cut into a sheet of A4 size, and ZAIKTHENE AC was applied onto one face of the sheet with a bar coater No. 12 manufactured by Dai-Ichi Rika K.K., and dried with a dryer at 120° C. for 5 minutes (paper layer/intermediate layer). Subsequently, the EVOH (A14) was added to a mixed solvent of n-propyl alcohol and water (n-propyl alcohol: 65 wt %, water: 35 wt %) to reach a solid content concentration of 15 wt % and stirred at 80° C. for 3 hours, and the complete dissolution of the EVOH (A14) was confirmed. The resulting solution was applied onto the face of the bleached kraft paper sheet coated with ZAIKTHENE AC with a bar coater No. 10 manufactured by Dai-Ichi Rika K.K., and then dried with a dryer at 120° C. for 5 minutes (paper layer/intermediate layer/modified EVOH (A) layer). A two-component adhesive (“TAKELAC™ A-385”/“TAKENATE A-10”) was applied onto an unstretched polypropylene film (CPP, thickness: 30 m) to give a basis weight of 2.5 g/m² in terms of solid contents, and then laminated on the modified EVOH (A) layer side of the bleached kraft paper sheet (paper layer/intermediate layer/modified EVOH layer) with a dry laminating method, giving a multilayer structure consisting of paper layer/intermediate layer/modified EVOH layer//sealant layer. A cross-section was formed with use of a microtome, the thickness of each layer was measured at five points under a microscope, and the mean was defined as the thickness of the layer.

### Gas Barrier Properties

Oxygen transmission rates were evaluated as gas barrier properties. A part was cut out of the obtained multilayer structure, and subjected to measurement under conditions of 20° C. and 65% RH in accordance with a method described in JIS K7126 (Equal-pressure method) with use of the oxygen transmission rate analyzer model OX-TRAN2/20 (detection limit value: 0.01 cc/m²·day·atm) manufactured by MOCON Inc. The obtained value was defined as OTR1, and evaluated on the basis of criteria shown below. A package including a bent part at a bending angle of 360° was produced from the multilayer structure, a part including the bent part at the center was cut out, the oxygen transmission rate thereof was measured, and the obtained value was defined as OTR2. Likewise, OTR2 was evaluated on the basis of the following criteria.

### <Rating Criteria>

A: 1.0 cc/m²·day·atm or less
B: more than 1.0 cc/m²·day·atm and 5.0 cc/m²·day·atm or less
C: more than 5.0 cc/m²·day·atm and 10.0 cc/m²·day·atm or less
D: more than 10.0 cc/m²·day·atm and 20 cc/m²·day·atm or less
E: more than 20 cc/m²·day·atm

### Gas Barrier Properties Before and After Forming Bent Part, OTR2/OTR1

The ratio (OTR2/OTR1) between the oxygen transmission rate of a part including no bent part, OTR1, and the oxygen transmission rate of a part including a bent part, OTR2, was evaluated on the basis of the following criteria.
A: OTR2/OTR1 was 1.0 or more and less than 1.5
B: OTR2/OTR1 was 1.5 or more and less than 3.0
C: OTR2/OTR1 was 3.0 or more and less than 5.0
D: OTR2/OTR1 was 5.0 or more and less than 10.0
E: OTR2/OTR1 was 10.0 or more

### Heat-Seal Strength

The heat-seal strength of the multilayer structure was measured in accordance with JIS Z 0238. A strip-like piece having a width of 15 mm was produced from the multilayer structure, and two parts of the same layer (two parts of the sealant layer or two parts of the modified EVOH (A) layer) were overlapped in contact with each other, and a part of 100 mm in length in the overlapping part was heat-sealed with a heat gradient tester manufactured by Toyo Seiki Seisaku-sho, Ltd. at 60° C. or 180° C. and a pressure of 2.0 kgf/cm² for 1 second. The T-peel strength (unit: gf/15 mm) of this measurement sample was measured with the autograph “model AGS-H” manufactured by Shimadzu Corporation under an environment at 23° C. and 50% RH at a tensile speed of 300 mm/min. The measurement was performed 10 times, and the average value was determined. Of the value obtained for heat-sealing at 160° C. and that for 180° C., the higher value was employed as the heat-seal strength, and evaluated on the basis of the following criteria.
A: 1500 gf/15 mm or more
B: 800 gf/15 mm or more and less than 1500 gf/15 mm
C: 500 gf/15 mm or more and less than 800 gf/15 mm
D: 300 gf/15 mm or more and less than 500 gf/15 mm
E: less than 300 gf/15 mm

### Appearance Characteristics and Taste for Package in Cashew Nuts Storage Test

The multilayer structure was cut to give a rectangle of 17 cm in length and 32 cm in width, the rectangle was bent at a position 8.5 cm away from each edge in the width direction, the edges were overlapped in such a manner that the edges were brought into contact in a width of 1 cm in the same layer. Then, the overlapping part (a trunk part 11b in FIG. 1) and one edge part in the length direction (an edge part 11a in FIG. 1) were each heat-sealed in a width of 1 cm; thus, a package was produced. Therein, 50 g of cashew nuts (water activity: 0.33) were put, and the other edge part in the length direction (an edge part 11a in FIG. 1) was heat-sealed to seal the package. The package was stored under conditions of 23° C. and 50% RH for 100 days, and the appearance of the package was visually observed and rated as follows. In the rating criteria for appearance characteristics, the degree of oil staining becomes more terrible in order of A, B, C, D, and E. Five panelists checked the taste of the cashew nuts, and held a consultation to determine the taste in accordance with criteria shown below. In the determination criteria for taste, the taste change increases in order of A, B, C, D, and E.

### Rating Criteria for Appearance Characteristics

A: No change
B: Very slight oil staining was found
C: Slight oil staining was found
D: Oil staining was found to some degree
E: Oil staining was clearly found

### Determination Criteria for Taste

A: Almost unchanged from the taste before storage
B: Changed very slightly from the taste before storage
C: Changed slightly from the taste before storage
D: Changed to some degree from the taste before storage
E: Changed from the taste before storage

The OTR1 of the multilayer structure before being processed into a package (a part including no bent part) was 0.32 cc/m²·day·atm, and the rating was A. The OTR after bending was measured to be 0.35 cc/m²·day·atm, giving OTR2/OTR1=1.1, and the rating was A. The heat-seal strength was 2800 gf/15 mm, and the rating was A. The evaluation of the appearance of the package after the cashew nuts storage test found that the appearance was unchanged, and the rating was A. The cashew nuts taste test after the storage found almost no change from the taste before the storage, and the rating was A.

### Examples 13 to 28, Comparative Example 7

Multilayer structures were obtained in the same manner as in Example 12 except that the paper layer, the type of modified EVOH (A), the thicknesses, the intermediate layer, and the heat-seal layer were changed as shown in Table 5. The thickness of the modified EVOH (A) layer and the thickness of the intermediate layer were adjusted by changing the depth (number) of the bar coater. The resulting multilayer structures were evaluated in the same manner as in Example 12. The evaluation results are shown in Table 5.

TABLE 5

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 12 | ple 13 | ple 14 | ple 15 | ple 16 | ple 17 | ple 18 | ple 19 | ple 20 | ple 21 |
| Multilayer | Paper layer | Type | Kraft paper | | | | | | | | | |
| structure | | Basis weight | 50 | 50 | 50 | 50 | 50 | 50 | 50 | 50 | 50 | 50 |
| | | (g/m²) | | | | | | | | | | |
| | Intermediate | Type | ZAIKTHENE AC | | | — | — | — | — | — | — | — |
| | layer | Thickness | 5 | 5 | 5 | — | — | — | — | — | — | — |
| | | (μm) | | | | | | | | | | |
| | | Density | 0.9 | 0.9 | 0.9 | — | — | — | — | — | — | — |
| | | (g/cm³) | | | | | | | | | | |
| | Modified | Type | A14 | A14 | A14 | A14 | A15 | A16 | A9 | A12 | A9 | A10 |
| | EVOH (A) | Content ratio | 27 | 27 | 27 | 27 | 27 | 27 | 38 | 38 | 38 | 38 |
| | layer or | of a (mol %) | | | | | | | | | | |
| | EVOH | Content ratio | 1.0 | 1.0 | 1.0 | 1.0 | 0.3 | 8.0 | 1.5 | 1.5 | 1.5 | 1.5 |
| | layer | of c (mol %) | | | | | | | | | | |
| | | Degree of | ≥99.9 | | | | | | | | | |
| | | saponification | | | | | | | | | | |
| | | (DS) (mol %) | | | | | | | | | | |
| | | Alkali metal | Na | Na | Na | Na | Na | Na | Na | Na | Na | Na |
| | | ion species | | | | | | | | | | |
| | | Alkali metal | 8.7 | 8.7 | 8.7 | 8.7 | 8.7 | 8.7 | 8.7 | 8.7 | 8.7 | 20 |
| | | ion content | | | | | | | | | | |
| | | (μmol/g) | | | | | | | | | | |
| | | Thickness | 5 | 5 | 5 | 5 | 5 | 5 | 10 | 2 | 5 | 5 |
| | | (μm) | | | | | | | | | | |
| | | Density | 1.2 | 1.2 | 1.2 | 1.2 | 1.2 | 1.2 | 1.2 | 1.2 | 1.2 | 1.2 |
| | | (g/cm³) | | | | | | | | | | |
| | Sealant | Type | PP | ZAIKTHENE | — | — | — | — | — | — | — | — |
| | layer | | laminate | AC | | | | | | | | |
| | | Thickness | 30 | 6 | — | — | — | — | — | — | — | — |
| | | (μm) | | | | | | | | | | |
| | | Density | 0.9 | 0.9 | — | — | — | — | — | — | — | — |
| | | (g/cm³) | | | | | | | | | | |
| | M1/M2¹⁾ | | 1.3 | 3.2 | 4.8 | 8.4 | 8.4 | 8.4 | 4.2 | 21.0 | 8.4 | 8.4 |

| | | | | | | | | | | | |
|---|---|---|---|---|---|---|---|---|---|---|---|
| Evaluation | OTR1²⁾ | A | A | A | A | A | A | B | C | B | B |
| result | OTR2³⁾ | A | A | A | B | B | A | C | B | C | C |
| | OTR2/OTR1 | A | A | A | C | D | B | D | B | B | B |
| | Heat-seal strength | A | B | C | D | D | C | C | D | C | C |
| | Appearance characteristics | A | A | B | B | B | B | D | D | C | C |
| | after storage | | | | | | | | | | |
| | Taste after storage | A | A | A | B | B | A | C | C | C | C |

| | | | | | | | | | | Compar- |
|---|---|---|---|---|---|---|---|---|---|---|
| | | | Exam- | Exam- | Exam- | Exam- | Exam- | Exam- | Exam- | ative |
| | | | ple 22 | ple 23 | ple 24 | ple 25 | ple 26 | ple 27 | ple 28 | Example 7 |
| Multilayer | Paper layer | Type | Kraft paper | | | Glassine | Kraft | Kraft | Kraft | Kraft |
| structure | | | | | | paper | paper | cardboard | cardboard | cardboard |
| | | Basis weight | 50 | 50 | 50 | 31 | 140 | 450 | 290 | 450 |
| | | (g/m²) | | | | | | | | |
| | Intermediate | Type | — | — | — | — | — | — | — | — |
| | layer | | | | | | | | | |
| | | Thickness | — | — | — | — | — | — | — | — |
| | | (μm) | | | | | | | | |
| | | Density | — | — | — | — | — | — | — | — |
| | | (g/cm³) | | | | | | | | |
| | Modified | Type | A11 | A12 | A13 | A9 | A9 | A9 | A17 | B5 |
| | EVOH (A) | Content ratio | 38 | 38 | 38 | 38 | 38 | 38 | 55 | 38 |
| | layer or | of a (mol %) | | | | | | | | |
| | EVOH | Content ratio | 1.5 | 1.5 | 1.5 | 1.5 | 1.5 | 1.5 | 1.0 | |
| | layer | of c (mol %) | | | | | | | | |

| | Degree of | ≥99.9 | | | | | | | |
|---|---|---|---|---|---|---|---|---|---|
| | saponification | | | | | | | | |
| | (DS) (mol %) | | | | | | | | |
| | Alkali metal | Na | Na | K | Na | Na | Na | Na | Na |
| | ion species | | | | | | | | |
| | Alkali metal | 2.6 | 0.4 | 8.7 | 8.7 | 8.7 | 8.7 | 8.7 | 8.7 |
| | ion content | | | | | | | | |
| | (μmol/g) | | | | | | | | |
| | Thickness | 5 | 5 | 5 | 5 | 5 | 5 | 6 | 5 |
| | (μm) | | | | | | | | |
| | Density | 1.2 | 1.2 | 1.2 | 1.2 | 1.2 | 1.2 | 1.1 | 1.2 |
| | (g/cm³) | | | | | | | | |
| Sealant | Type | — | — | — | — | — | — | — | — |
| layer | Thickness | — | — | — | — | — | — | — | — |
| | (μm) | | | | | | | | |
| | Density | — | — | — | — | — | — | — | — |
| | (g/cm³) | | | | | | | | |
| M1/M2¹⁾ | | 8.4 | 8.4 | 8.4 | 5.2 | 23.5 | 75.6 | 43.9 | 76.9 |

| | | | | | | | | | |
|---|---|---|---|---|---|---|---|---|---|
| Evaluation | OTR1²⁾ | B | B | B | B | B | B | D | B |
| result | OTR2³⁾ | C | D | C | C | D | D | D | E |
| | OTR2/OTR1 | B | C | B | C | C | D | A | E |
| | Heat-seal strength | C | C | C | C | C | C | B | E |
| | Appearance characteristics | C | D | C | D | D | D | D | E |
| | after storage | | | | | | | | |
| | Taste after storage | C | D | C | C | D | D | D | E |

¹⁾Ratio between weight of paper layer, M1, and total weight of the other layer(s), M2,
²⁾Oxygen transmission rate of part including no bent part,
³⁾Oxygen transmission rate of part including bent part

As demonstrated in Examples, the coating agent of the present invention shows good storage stability, and the gas barrier properties and appearance of a coating film to be given are also good. The multilayer structure obtained by applying the coating agent onto a substrate can be preferably used for various packaging materials and the like. The multilayer structure comprising a layer formed by applying the coating agent and a paper layer has good gas barrier properties in spite of using a paper substrate (paper layer) and is capable of maintaining the good gas barrier properties even after bending. Furthermore, the multilayer structure has a heat-seal strength sufficient for a package.

### REFERENCE SIGNS LIST

10 vertical filling-and-sealing bag
11 multilayer structure
11a edge part
11b trunk part

1. A coating agent comprising a modified ethylene-vinyl alcohol copolymer (A), wherein the modified ethylene-vinyl alcohol copolymer (A) contains structural units (Ia), (Ib), and (Ic) represented by formulas shown below, content ratios (mol %) of the structural units (Ia), (Ib), and (Ic), a, b, and c, satisfy expressions (1) to (3) shown below, the modified ethylene-vinyl alcohol copolymer (A) has a degree of saponification (DS), as expressed by expression (4) shown below, of 90 mol % or more: 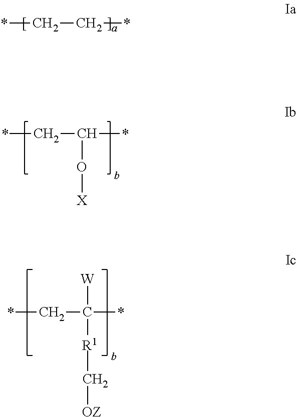
$$21 \leq a \leq 55 \qquad ( 1 )$$
$$0.1 \leq c \leq 10 \qquad ( 2 )$$
$$[ 100 - ( a + c ) ] \times 0.9 \leq b \leq [ 100 - ( a + c ) ] \qquad ( 3 )$$
$$D S = [ ( total number of moles of hydrogen atoms among X , Y , and Z groups ) / ( total number of moles of X , Y , and Z groups ) ] \times 100 \qquad ( 4 )$$
wherein: each of a, b, and c is a content ratio (mol %) of the corresponding structural unit to 100 mol % of a total of all the structural units; W represents a methyl group or a group represented by R²—OY; X, Y, and Z each independently represent a hydrogen atom, a formyl group, or an alkanoyl group having 2 to 10 carbon atoms; R¹ represents a single bond, an alkylene group having 1 to 9 carbon atoms, or an alkyleneoxy group having 1 to 9 carbon atoms, wherein each of the alkylene group and the alkyleneoxy group optionally contains a hydroxy group, an alkoxy group, or a halogen atom; R² represents an alkylene group having 1 to 9 carbon atoms or an alkyleneoxy group having 1 to 9 carbon atoms, wherein each of the alkylene group and the alkyleneoxy group optionally contains a hydroxy group, an alkoxy group, or a halogen atom; and * indicates a bonding site.

2. The coating agent according to claim 1, wherein, in the structural unit (Ic), W is a group represented by R²—OY, R¹ is a single bond, R² is a methylene group, and Y and Z are each a hydrogen atom.

3. The coating agent according to claim 1, wherein the modified ethylene-vinyl alcohol copolymer (A) has a degree of saponification (DS) of 99 mol % or more.

4. The coating agent according to claim 1, having a content of the modified ethylene-vinyl alcohol copolymer (A) of 1 to 50% by weight.

5. The coating agent according to claim 1, comprising an ethylene-vinyl alcohol copolymer (B) other than the modified ethylene-vinyl alcohol copolymer (A), and the ethylene-vinyl alcohol copolymer (B) has an ethylene content of 21 to 55 mol %.

6. The coating agent according to claim 5, having a total content of the modified ethylene-vinyl alcohol copolymer (A) and the ethylene-vinyl alcohol copolymer (B) of 1 to 50% by weight.

7. The coating agent according to claim 1, comprising 10 to 10,000 ppm of inorganic microparticles having an average particle size of 0.1 to 10 μm.

8. The coating agent according to claim 7, wherein the inorganic microparticles are made of amorphous silica.

9. The coating agent according to claim 1, wherein the coating agent is a solution of the modified ethylene-vinyl alcohol copolymer (A) with a solvent, and the solvent is a mixed solvent of an alcohol and water.

10. The coating agent according to claim 9, wherein a difference (T₀−T₇) between a light transmittance of the coating agent at a wavelength of 800 nm for an optical path length of 1 cm after storage at 20° C. for 7 days, T₇ (%), and a light transmittance of the coating agent at a wavelength of 800 nm for an optical path length of 1 cm before storage, T₀(%), is 20% or less.

11. The coating agent according to claim 9, wherein a change rate of a solution viscosity of the coating agent after storage thereof at 20° C. for 1 week is 50% or less to a solution viscosity of the coating agent before the storage.

12. A multilayer structure formed by applying the coating agent according to claim 1 onto a substrate.

13. A multilayer structure comprising a layer formed by applying the coating agent according to claim 1 and a paper layer.

14. The multilayer structure according to claim 13, wherein the paper layer has a basis weight of 15 to 800 g/m².

15. The multilayer structure according to claim 13, wherein the modified ethylene-vinyl alcohol copolymer (A) contains an alkali metal ion, and has an alkali metal ion content of 2.5 to 22 μmol/g.

16. The multilayer structure according to claim 13, having an oxygen transmission rate of 20 cc/(m²·day·atm) or less as measured under conditions of 20° C. and 65% RH in accordance with JIS-K7126-2 (2006) Part 2 (Equal-pressure method).

17. The multilayer structure according to claim 13, having a heat-seal strength of 300 gf/15 mm or more as measured at a width of 15 mm in accordance with JIS Z 0238.

18. The multilayer structure according to claim 13, further comprising an intermediate layer and a sealant layer.

19. The multilayer structure according to claim 18, wherein the intermediate layer contains a thermosetting resin or a thermoplastic resin (f).

20. The multilayer structure according to claim 18, wherein the sealant layer contains a thermoplastic resin (g).

21. The multilayer structure according to claim 19, wherein the thermoplastic resin (f) and the thermoplastic resin (g) each contain at least one selected from the group consisting of polyethylene, polypropylene, modified polyethylene, and modified polypropylene.

22. The multilayer structure according to claim 13, wherein a weight of the paper layer, M1, and a total weight of the other layer(s), M2, satisfy the following expression (5):
$$1 \leq M 1 / M 2 \leq 300. \qquad ( 5 )$$

23. A package comprising the multilayer structure according to claim 13 with one or more bent parts.

24. The package according to claim 23, wherein a content to be contained in the package is a food, and the food has a water activity of 0.10 to 0.94.
